(19) United States
(12) Patent Application Publication
(10) Pub. No.: US 2002/0054222 A1
(43) Pub. Date: May 9, 2002

(54) Image capturing system, and recording medium for control program of image capturing system

(75) Inventors: Keiichi Nitta, Kawasaki-shi (JP); Masahiro Mochizuki, Yokohama-shi (JP)

Correspondence Address: OLIFF & BERRIDGE, PLC, P.O. BOX 19928, ALEXANDRIA, VA, 22320, US

(73) Assignee: Nikon Corporation, Chiyoda-ku (JP)

(21) Appl. No.: 09/874,964

(22) Filed: Jun. 7, 2001

(30) Foreign Application Priority Data
Jun. 8, 2000 (JP) P2000-171689

(51) Int. Cl. H04N 5/222

(52) U.S. Cl. 348/231; 348/333.01

(57) ABSTRACT

A control circuit allows a memory to start a data write through external access at a time point corresponding to timing O. When a reproduction switch is operated at a time point corresponding to timing Y, the control circuit interrupts the write operation at the memory by deactivating a write control signal. The control circuit also allows the memory to start a read operation by activating a read control signal. The data read out from the memory are provided to an encoder/decoder circuit. Once the data read is completed, the control circuit deactivates the read control signal and activates the write control signal at a time point corresponding to timing P. The memory resumes the data write operation through the external access which has been interrupted since the time point Y.

### INCORPORATION BY REFERENCE

The disclosure of the following priority application is herein incorporated by reference: Japanese Patent Application No. 2000-171689 filed Jun. 8, 2000

### BACKGROUND OF THE INVENTION

1. Field of the Invention

The present invention relates to an image capturing system that captures an image of a subject and outputs image information, such as a digital still camera, a presentation document camera or the like. It also relates to a recording medium having recorded therein a procedure for controlling the image capturing system.

2. Description of the Related Art

There are image capturing systems in the known art that capture an image of a subject with a camera and output an image signal used to display the captured subject image. Such an image capturing system may be connected with an external apparatus that transmits image data. The image capturing system selects either an image signal constituted with the image data transmitted from the connected external apparatus or an image signal obtained through an image capturing operation performed on the camera of the image capturing system and outputs the selected image signal. In addition, the image capturing system is provided with a semiconductor memory in which image data are recorded. When the image capturing system outputs the image signal obtained through the image capturing operation performed on the camera, the image data resulting from the image capturing operation are recorded in the semiconductor memory and the image signal is output by reading out the recorded image data. When the image capturing system outputs the image signal constituted with the image data transmitted from the external apparatus, the image data from the external apparatus are recorded in the semiconductor memory and the image signal is output by reading out the recorded image data.

In the image capturing system described above, a read of image data from the semiconductor memory is disallowed while recording the image data from the external apparatus into the semiconductor memory. As a result, image data having been recorded in the semiconductor memory cannot be read out until the image data transmitted from the external apparatus are recorded completely. Thus, a problem arises in that if image data are continuously transmitted from the external apparatus to the image capturing system, the image data must be recorded in the semiconductor memory over an extended period of time, lengthening the state in which image data cannot be read out from the semiconductor memory.

### SUMMARY OF THE INVENTION

An object of the present invention is to provide an image capturing system that allows internal access to a means for storage such as a memory within the image capturing system during external access to the means for storage (recording) from an external apparatus, and a recording medium having recorded therein a control procedure to be implemented on the image capturing system.

In order to achieve the object described above, the image capturing system (or the imaging system) according to the present invention comprises an image capturing element (or an imaging element) that captures an image of a subject (or images a subject) and outputs image information, a storage circuit in which the image information is stored, a switch through which a start instruction is issued to start internal access to the storage circuit in response to an operation performed by the user, an interface that enables communication with an external apparatus and a control circuit that interrupts external access and executes internal access to the storage circuit if the start instruction is received during the external access in which the external apparatus accesses the storage circuit via the interface.

The start instruction maybe an instruction for starting a write of the image information output by the image capturing element, and the image information from the image capturing element may be written into the storage circuit through internal access.

The image capturing system according to the present invention may further comprise a display storage circuit employed to output the image information stored in the storage circuit to a display device, and in such a case, the start instruction may be an instruction for updating the image information stored in the display storage circuit and the image information stored in the storage circuit may be read out to the display storage circuit through internal access.

The image information received from the external apparatus via the interface may be written into the storage circuit through external access.

The image information recorded in the storage circuit may be read out to the external apparatus via the interface through external access, instead.

The control circuit may disallow external access until internal access following the interruption of the external access is completed.

The control circuit may execute internal access and external access alternately until the internal access following the interruption of the external access is completed.

The control circuit may output internal access end information to the external apparatus via the interface based upon the fact that internal access is completed, after the external access through which the image information received from the external apparatus via the interface is written into the storage circuit is interrupted.

The control circuit may interrupt external access through which the image information received from the external apparatus via the interface is written into the storage circuit, and output access restart time information indicating when the communication with the external apparatus is allowed to resume to the external apparatus via the interface.

The control circuit may restart external access based upon the fact that internal access is completed, after the external access through which the image information stored in the storage circuit is read out to the external apparatus via the interface is interrupted.

The control circuit may interrupt external access through which the image information stored in the storage circuit is read out to the external apparatus via the interface, and output access restart time information indicating when the communication with the external apparatus is allowed to resume to the external apparatus via the interface.

The image capturing system according to the present invention may further comprise a buffer in which a portion of the image information is temporarily stored before the image information stored in the storage circuit is read out to the external apparatus via the interface and the control circuit may output the portion of the image information stored in the buffer to the external apparatus via the interface when an image information transfer request is issued by the external apparatus before internal access following the interruption of external access, through which the image information stored in the storage circuit is read out to the external apparatus via the interface, is completed.

In order to achieve the object described above, the recording medium according to the present invention has recorded therein a control processing program for an image capturing system, and the program executes an image capturing instruction for capturing an image of a subject and outputting image information, a storage instruction for storing the image information in a storage circuit, a start instruction for starting internal access to the storage circuit in response to an operation performed by the user, a communication instruction for communicating with an external apparatus and an execution instruction for interrupting external access and executing internal access to the storage circuit when the start instruction is received during the external access in which the external device accesses the storage circuit.

### BRIEF DESCRIPTION OF THE DRAWINGS

FIG. 1 is a schematic block diagram of the image capturing system achieved in an embodiment of the present invention;

FIG. 2A shows image data written in the memory;

FIG. 2B shows the operation signal generated through the reproduction switch;

FIG. 2C shows the write control signal input to the memory;

FIG. 2D shows the read control signal input to the memory;

FIG. 2E shows the data at the input/output port of the memory;

FIG. 3 schematically illustrates packet data communication achieved in conformance to TCP;

FIG. 4A shows image data read out from the memory;

FIG. 4B shows the operation signal generated through the record switch;

FIG. 4C shows the write control signal input to the memory;

FIG. 4D shows the read control signal input to the memory;

FIG. 4E shows the data at the input/output port of the memory;

FIG. 5 schematically illustrates packet data communication achieved in conformance to TCP;

FIG. 6A shows image data written in the memory;

FIG. 6B shows an operation signal generated through the reproduction switch;

FIG. 6C shows the write control signal input to the memory;

FIG. 6D shows the read control signal input to the memory;

FIG. 6E shows the data at the input/output port of the memory;

FIG. 7 schematically illustrates packet data communication achieved in conformance to TCP;

FIG. 8 schematically illustrates packet data communication achieved in conformance to TCP;

FIG. 9A shows image data written in the memory;

FIG. 9B shows the operation signal generated through the reproduction switch;

FIG. 9C shows the write control signal input to the memory;

FIG. 9D shows the read control signal input to the memory;

FIG. 9E shows the data at the input/output port of the memory;

FIG. 10 schematically illustrates packet data communication achieved in conformance to TCP;

FIG. 11 schematically illustrates packet data communication achieved in conformance to TCP; and

FIG. 12 schematically illustrates packet data communication achieved in conformance to TCP.

### DESCRIPTION OF THE PREFERRED EMBODIMENTS

First Embodiment

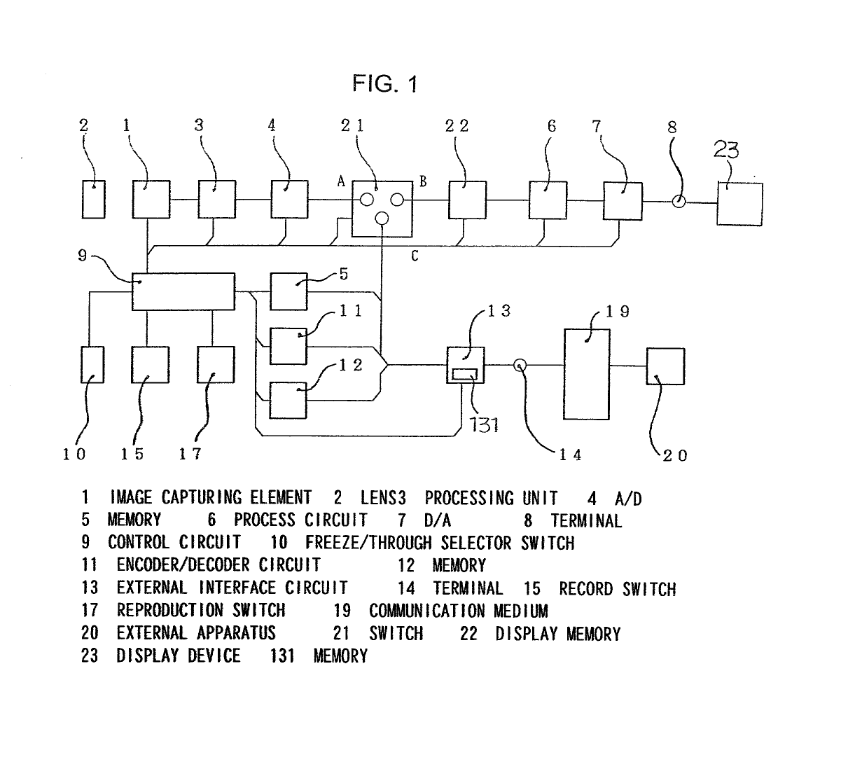

FIG. 1 is a block diagram schematically illustrating the structure of the image capturing system (the imaging system) achieved in the first embodiment of the present invention. In FIG. 1, the image capturing system comprises a lens 2, an image capturing element 1, a processing unit 3, an A/D conversion circuit 4, a switch 21, a display memory 22, a process circuit 6, a D/A conversion circuit 7 and a control circuit 9. The lens 2 forms an image of a subject (not shown) on an image capturing surface of the image capturing element 1. The image capturing element 1 performs photoelectric conversion on the optical image formed on the image capturing surface and outputs an image signal. The processing unit 3 performs specific types of processing such as correlational double sampling (CDS) processing on the image signal output from the image capturing element 1. The A/D conversion circuit 4 converts the image signal having undergone the processing at the processing unit 3 to a digital image signal.

The switch 21 is the dual-circuit selector switch having a terminal A, a terminal B and a terminal C. The switch 21 is capable of connecting/disconnecting two terminals among the terminals A˜C for each circuit. The display memory 22 is a frame memory in which digital image data corresponding to at least one frame (one field or one image plane) are recorded. The process circuit 6 engages in a specific types of signal processing such as high frequency emphasis processing on the digital image data read out from the display memory 22. The D/A conversion circuit 7 converts the digital image data having undergone the signal processing to an analog display image signal. A display device 23 is connected to a terminal 8. When the analog display image signal is output to the display device 23, an image corresponding to the analog display image signal is displayed on the display device 23.

The image capturing system is further provided with a memory 5, an encoder/decoder circuit 11, a memory 12, an external interface circuit 13, a freeze/through selector switch 10, a record switch 15 and a reproduction switch 17. Digital image data corresponding to at least one frame are recorded in the memory 5. The encoder/decoder circuit 11 implements encoding processing on the image data recorded in the memory 5 to compress the image data into a specific format such as the JPEG format. In the memory 12, the image data having been compressed at the encoder/decoder circuit 11 are recorded. The encoder/decoder circuit 11 also implements decompression processing on image data having undergone the compression processing. The decompression processing is achieved by the encoder/decoder circuit 11 by executing decoding processing on compressed image data recorded in the memory 12. The decoded image data are then recorded in the memory 5 mentioned earlier.

The external interface circuit 13, which includes Bluetooth enabling short-distance wireless communication, engages in image data communication with an external apparatus to be detailed later. An external device 20 is connected to a terminal 14 via a communication medium 19 such as a token ring network. The external device 20 is provided with a recording device capable of, for instance, recording image data and reading out recorded image data. More specifically, the external device 20 includes a computer, a server, a memory card, a storage unit and the like. The external interface circuit 13 receives image data transmitted from the external device 20 in conformance to a specific communication protocol via the communication medium 19 and sends the received image data to the memory 12. In addition, the external interface circuit 13 transmits image data read out from the memory 12 to the external device 20 in conformance to the specific communication protocol via the communication medium 19. The external interface circuit 13 is provided with a memory 131 which is to be detailed later. It is to be noted that the external device 20 is provided with an external interface circuit (not shown) to achieve a connection with the communication medium 19.

The control circuit 9 generates and outputs an operation timing signal for the image capturing element 1, a control signal for the processing unit 3, a conversion clock signal for the A/D conversion circuit 4 and the D/A conversion circuit 7 and a control signal for the process circuit 6. The control circuit 9 also generates and outputs a switching control signal for the switch 21, a write control signal and a read control signal for the display memory 22, the memory 5 and the memory 12 and a control signal for the encoder/decoder circuit 11 and the external interface circuit 13.

The freeze/through selector switch 10 outputs a freeze/through switching operation signal to the control circuit 9. Through the record switch 15, an operation signal for recording image data into the memory 12 is output to the control circuit 9. Through the reproduction switch 17, an operation signal for reading out image data from the memory 12 and reproducing the image data is output to the control circuit 9.

The image capturing system described above engages in five basic operations: 1; through operation, 2; freeze operation 3; record operation 4; reproduction operation and 5; data communication (transmission) operation. In the through operation, at least the terminal A and the terminal B at the switch 21 are connected and a display image signal corresponding to the image signal output from the image capturing element 1 is output to the display device 23. The image data carried by the image signal output from the image capturing element 1 are sequentially recorded into the display memory 22 via the switch 21. Image data for individual image screens recorded in the display memory 22 are sequentially read out from the display memory 22 and are displayed at the display device 23. As a result, the movement of the subject, the image of which is captured at the image capturing element 1, is reflected in the image displayed at the display device 23 in real time. It is to be noted that during the through operation, the A terminal and the C terminal of the switch 21 are also connected. Thus, the image data carried by the image signal output from the image capturing element 1 are also sequentially recorded into the memory 5 via the switch 21.

In the freeze operation, a write of new image data into the display memory 22 and the memory 5 is prohibited and a display image signal constituted of image data for one frame recorded in the display memory 22 is output to the display device 23. The image data recorded in the display memory 22 are repeatedly read out and displayed at the display device 23. As a result, the display image constituted of the image data recorded in the display memory 22, bearing no relation to the image data obtained through the real time image capturing operation and output from the image capturing element 1, is displayed at the display device 23.

The operator selects either the through operation or the freeze operation by operating the freeze/through selector switch 10. Each time an operation signal is input through the freeze/through selector switch 10, the control circuit 9 sets the write control signal for the display memory 22 and the memory 5 to an active state or a non-active state. When the write control signal is activated, the display memory 22 and the memory 5 sequentially record new image data, whereas when the write control signal is deactivated, the display memory 22 and the memory 5 halt image data recording.

In the record operation, image data corresponding to one frame which has been obtained through an image capturing operation performed at the image capturing element 1 are compressed at the encoder/decoder circuit 11 and the compressed image data are recorded in the memory 12. When the record operation is started, at least the terminal A and the terminal C at the switch 21 are connected so as to allow the image data for one frame carried in the image signal output from the image capturing element 1 are recorded in the memory 5. Once the image data has been recorded in the memory 5, the terminal A and the terminal C at the switch 21 may become disconnected from each other. Then, the image data are read out from the memory 5 and are input to the encoder/decoder circuit 11. The encoder/decoder circuit 11 performs compression processing on the image data thus input, and the compressed image data are recorded in the memory 12. The record operation described above is executed when the operator operates the record switch 15. When an operation signal is input through the record switch 15, the control circuit 9 compresses the image data for one frame obtained through an image capturing operation performed at the image capturing element 1 by engaging the encoder/decoder circuit 11 and records the compressed image data in the memory 12.

In the reproduction operation, a display image signal constituted of the compressed image data recorded in the memory 12 is output to the display device 23. When the reproduction operation is started, at least the connection between the terminal A and the terminal C at the switch 21 becomes disconnected. Compressed image data for a specific frame are read out from the memory 12 and the image data thus read out are input to the encoder/decoder circuit 11. The compressed image data input to the encoder/decoder circuit 11 undergo decompression processing at the encoder/decoder circuit 11 and the decompressed image data are recorded in the memory 5. Once the decompressed image data are recorded into the memory 5, the terminal C and the terminal B at the switch 21 become connected with each other. The decompressed image data are read out from the memory 5 and are recorded in the display memory 22 via the switch 21.

The image data recorded in the display memory 22 are repeatedly read out and are displayed at the display device 23. As a result, the display image constituted of the image data recorded in the display memory 22, bearing no relation to the image data obtained through the real time image capturing operation and output from the image capturing element 1, is displayed at the display device 23. The reproduction operation described above is executed when the operator operates the reproduction switch 17. When an operation signal is input through the reproduction switch 17, the control circuit 9 engages the encoder/decoder circuit 11 to decompress the compressed image data corresponding to a specific frame recorded in the memory 12 and outputs a display image signal constituted of the decompressed image data to the display device 23.

The data communication operation includes a receive operation and a transmit operation. In the receive operation, image data transmitted from the external device 20 via the communication medium 19 are received and the received image data are recorded in the memory 12. In the transmit operation, image data recorded in the memory 12 are read out from the memory 12 and the image data thus read out are transmitted to the external device 20 via the communication medium 19. During the data communication operation, at least the terminal A and the terminal C at the switch 21 are disconnected from each other.

When the external device 20 transmits a command to the image capturing system requesting that the image capturing system receive image data, the command is received by the external interface circuit 13 of the image capturing system. In response to the reception request command received at the external interface circuit 13, the image capturing system starts a receive operation. The external interface circuit 13 transmits a signal to the control circuit 9 indicating that the command that has been received. The control circuit 9 outputs a control signal to the external interface circuit 13 to allow the external interface circuit 13 to receive the data. The external interface circuit 13 receives the data transmitted in conformance to a specific communication format and converts the data to image data. When the control circuit 9 outputs the write control signal to the memory 12, the image data are recorded into the memory 12.

When the external device 20 transmits a command to the image capturing system requesting that the image capturing system transmit image data, the command is received at the external interface circuit 13. Upon receiving the transmission request command at the external interface circuit 13, the image capturing system starts a transmit operation. The external interface circuit 13 transmits a signal indicating the command that has been received to the control circuit 9. The control circuit 9 outputs the read control signal to the memory 12. The image data read out from the memory 12 are converted at the external interface circuit 13 in conformance to a specific communication format. The data having undergone the format conversion are then transmitted to the external device 20 via the communication medium 19 in conformance to the specific communication protocol.

While the external device 20 issues a command to the image capturing system requesting that image data be received or transmitted in this example, a command may be issued by the image capturing system to the external device 20 requesting that image data be received or transmitted instead. For instance, the image capturing system may issue a command for transmitting the image data to the external device 20 when the storage capacity of the memory 12 provided in the image capturing system has become almost depleted due to repeated image capturing, to transmit data having undergone the format conversion to the external device 20.

At the memory 12, in which image data are recorded, a single input/output port functions both as a data input port through which data to be written are input and as a data output port through which data to be read out are output. As a result, while either a write operation or a read operation is in progress at the memory 12, the other operation cannot be executed. In addition, the memory 12 is engaged during the record operation and the reproduction operation and also during the data transmit operation and the data receive operation explained earlier. In this context, implementing write control or read control on the memory 12 in order to record image data in the memory 12 during the record operation or to read out image data from the memory 12 during the reproduction operation is referred to as internal access to the memory 12. Implementing write control or read control on the memory 12 in order to record image data in the memory 12 during the receive operation or to read out image data from the memory 12 during the transmit operation, on the other hand, is referred to as external access to the memory 12. The present invention is characterized by the operation achieved when external access and internal access to the memory 12 are concurrently attempted. An explanation is given below by focusing on the control implemented to interrupt external access and execute internal access if the internal access is attempted while the external access is in progress and to resume the external access when the internal access is completed.

1-1 A data Read Achieved Through Internal Access Attempted While Data Write Through a External Access is in Progress

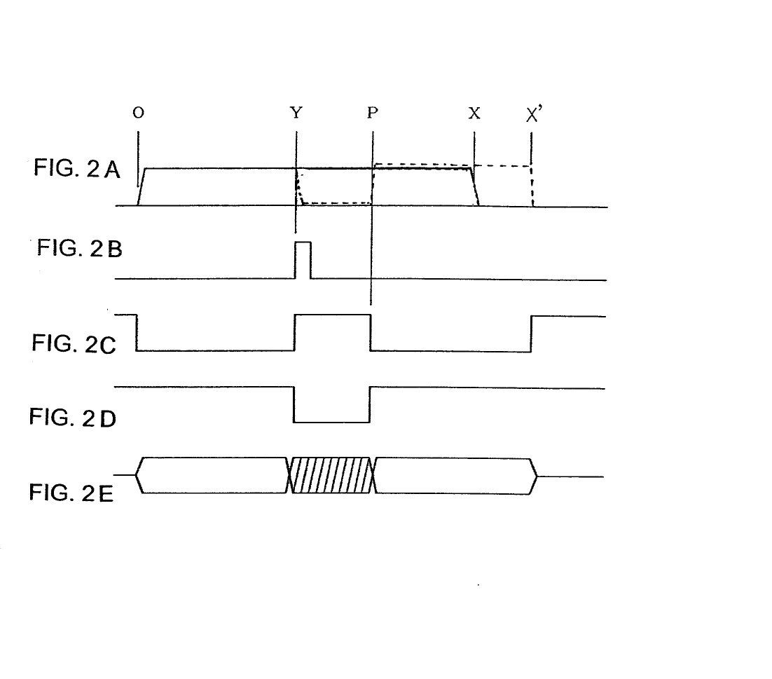

Now, an explanation is given on a situation in which the reproduction switch 17 is operated while the image capturing system is engaged in the receive operation described earlier. In the first embodiment, if the reproduction switch 17 is operated while a data write into the memory 12 is in progress through the receive operation, the data write into the memory 12 is interrupted, and the reproduction operation is executed by reading out data from the memory 12. FIGS. 2A˜2E present time charts of the write control and the read control implemented on the memory 12. FIG. 2A shows the image data written into the memory 12. FIG. 2B shows the operation signal input through the reproduction switch 17. FIG. 2C shows the write control signal input to the memory 12. FIG. 2D shows the read control signal input to the memory 12. FIG. 2E shows the data at the input/output port at the memory 12.

In FIGS. 2A˜2E, a data write into the memory 12 is started through external access initiated at a time point corresponding to timing O. Unless the reproduction switch 17 is operated while the data write is in progress, the data write is completed at a time point corresponding to timing X. The solid line in FIG. 2A represents the waveform manifesting when the reproduction switch 17 is not operated. When the reproduction switch 17 is operated at a time point corresponding to timing Y in FIG. 2B, the control circuit 9 interrupts the data write into the memory 12. In FIG. 2C, the write control signal is in an active state when it is at low level and is in a non-active state when it is at high level. The control circuit 9 activates the write control signal at the time point O to allow the memory 12 to start a write operation. In response to the operation signal input through the reproduction switch 17 at the time point corresponding to timing Y, the control circuit 9 deactivates the write control signal to interrupt the write operation at the memory 12.

In FIG. 2D, the read control signal is in an active state when it is at low level and is in a non-active state when it is at high level. The control circuit 9 deactivates the read control signal during a receive operation to disallow a read operation at the memory 12. However, once the reproduction switch 17 is operated, the control circuit 9 activates the read control signal at the time point corresponding to timing Y to allow the memory 12 to start the read operation. This read operation is performed to send image data recorded in the memory 12 to the encoder/decoder circuit 11. In FIG. 2E, the shaded block indicates the data read out from the memory 12. Namely, at the input/output port of the memory 12, the data to be written into the memory 12 are present between the time point O and the time point Y, and the data read out from the memory 12 are present following the time point Y up to a time point corresponding to timing P which is to be detailed later.

When the data read performed to send the image data to the encoder/decoder circuit 11 is completed, the control circuit 9 deactivates the read control signal and activates the write control signal at the time point P. The memory 12 resumes the data write operation which was interrupted at the time point Y. Once the data write through the external access is completed, the control circuit 9 deactivates the write control signal at a time point corresponding to timing X′. The dotted line in FIG. 2A represents the waveform manifesting between the time point P at which the data write into the memory 12 is resumed and the time point X′ at which the data write is completed. The length of time elapsing between the time point X and the time point X′ is equivalent to the length of time that elapses and between the time point Y at which the data write was interrupted in response to the operation of the reproduction switch 17 performed while the data write was in progress and the time point P.

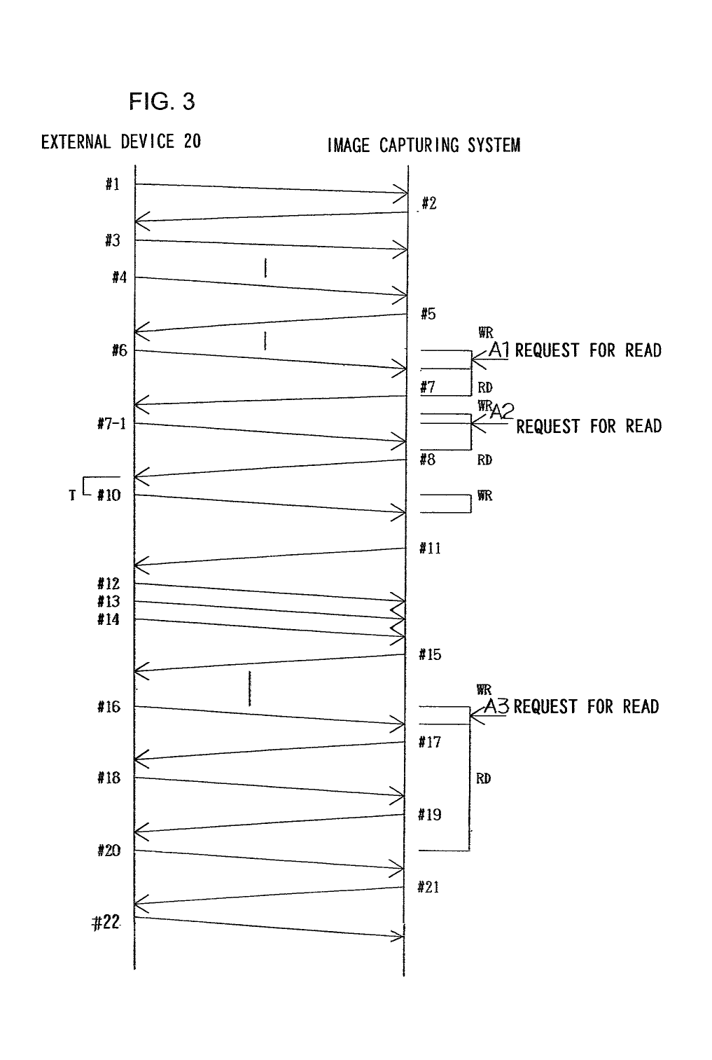

An explanation is given on the relationship between the write control and the read control implemented on the memory 12 described above, and the data communication achieved between the external interface circuit 13 and the external device 20. FIG. 3 schematically illustrates the data communication achieved in conformance to TCP (transmission control protocol). The data communication between the external interface circuit 13 and the external device 20 may be achieved through, for instance, packet communication. In FIG. 3, the left side represents the external device 20 and the right side represents the image capturing system achieved in the first embodiment. In addition, the time is indicated along the vertical direction and the time advances toward the bottom in FIG. 3. Each arrow appended with # in the figure indicates a flow of data between the external device 20 and the image capturing system. FIG. 3 only presents the essential part of the data communication to facilitate the explanation and does not show the entire flow of the actual data.

After executing the read operation by interrupting the write operation in progress at the memory 12 at the time point Y in FIGS. 2A˜2E, the write operation may be resumed at the time point P through one of the following three methods.

1-1-1 Temporarily Suspending Transmission of Acknowledgement

In step #1 in FIG. 3, the external device 20 issues a line connection request to the image capturing system. In step #2, the interface circuit 13 of the image capturing system transmits a line connection response and a line connection request to the external device 20. In step #3, the external device 20 transmits a line connection response. Through the processing implemented in steps #1˜#3, the line connection between the external device 20 and the image capturing system is established. It is to be noted that the line connection requests described above each refer to a verification of the sequence number attached to the data to transmitted/received. The sequence numbers are assigned in order to assure the reliability of the data communication.

In step #4, the external device 20 transmits a packet containing image data. The interface circuit 13 of the image capturing system performs a checksum error detection on the received data. In step #5, the interface circuit 13 transmits an acknowledgement if no error has been detected. The checksum error detection is executed each time a packet is received by the interface circuit 13. The interface circuit 13 does not transmit an acknowledgement if an error is detected.

In step #6, the external device 20 transmits a packet containing image data again. The image data constituting one frame are divided into a plurality of portions and a plurality of packets each containing an image data portion resulting from the division are transmitted one at a time from the external device 20. Upon receiving the packet transmitted in step #6, the interface circuit 13 converts the received packet to image data. The image data obtained through the conversion are sequentially recorded into the memory 12. After outputting the image data contained in the received packet, the interface circuit 13 transmits an acknowledgement to the external device 20. Upon receiving the acknowledgement transmitted from the interface circuit 13, the external device 20 transmits the next packet. If the reproduction switch 17 explained earlier is operated (arrow A1) while the image capturing system is recording image data into the memory 12 (during a WR), the control circuit 9 records the image data contained in a packet that has already been received at the interface 13 into the memory 12. In addition, the control circuit 9 implements control on the interface circuit 13 so that no acknowledgement is transmitted to the external device 20. As a result, the external device 20 does not transmit a new packet.

In the meanwhile, the control circuit 9 allows the memory 12 to start a read operation (RD). The read operation is performed at the memory 12 to send in the image data required for the reproduction operation mentioned earlier to the encoder/decoder circuit 11 from the memory 12. Once the read of the image data for one frame required for the reproduction operation is completed, the control circuit 9 implements control on the interface circuit 13 so as to allow it to transmit an acknowledgement with regard to the packet transmitted in step #6. In step #7, the interface circuit 13 transmits the acknowledgement to the external device 20 only if no error has been detected through a checksum operation. As a result, the external device 20 transmits a new packet containing image data instep#7-1. Upon receiving the transmitted packet, the interface circuit 13 converts the received packet to image data. The image data obtained through conversion are sequentially recorded in the memory 12.

1-1-2 Setting Time Period T

In step #7-1, the external device 20 transmits a packet containing image data. An explanation is given below on a situation in which the reproduction switch 17 is operated (arrow A2) while a write (WR) of the image data in the packet transmitted from the external device 20 into the memory 12 is in progress at the image capturing system. The control circuit 9 halts the processing for recording the image data contained in the packet already received at the interface circuit 13 into the memory 12. The control circuit 9 also allows the memory 12 to start a read operation (RD) immediately. This read operation is executed to send the image data required for the reproduction operation explained earlier to the encoder/decoder circuit 11 from the memory 12.

In step #8, the interface circuit 13 issues a request that the packet containing the image data transmitted from the external device 20 in step #7-1 be transmitted after a period T. The period T is set longer than the length of time required to read out the image data corresponding to one frame from the memory 12 to be used in the reproduction operation. As a result, in step #10 following the period T which has elapsed after the request transmitted from the interface circuit 13 in step #8 was received, the external device 20 transmits the packet containing the same image data as the image data the packet transmitted in step #7-1. By the time the packet transmitted in step #10 is received in the image capturing system, the image data read from the memory 12 is completed. Upon receiving the packet transmitted instep#10, the interface circuit 13 converts the received packet to image data. The image data resulting from the conversion are sequentially recorded into the memory 12.

Now, an explanation is given with regard to the window size. In step #11, the interface circuit 13 transmits the window size value together with an acknowledgement with regard to the packet transmitted in step #10. The window size refers to the protocol set on the transmission side by the reception side in order to improve the communication efficiency of communication implemented in conformance to the TCP. The window size refers to the number of packets that can be continuously transmitted from the transmission side to the reception side, and may be set at three, for instance. The window size value can be dynamically varied.

Upon receiving “window size=3” transmitted in step #11, the external device 20 transmits three packets containing image data in step #12˜step #14. In step #15, the interface circuit 13 transmits an acknowledgement with regard to the packets transmitted in steps #12˜#14 and “window size=1”.

In step #16, the external device 20 transmits a new packet containing image data. Upon receiving the transmitted packet, the interface circuit 13 converts the received packet to image data. The image data resulting from the conversion are sequentially recorded into the memory 12. As described above, by setting the window size, the number of packets to be transmitted continuously can be varied. In addition, as explained below, a packet which does not contain image data may be transmitted by setting the window size to zero.

1-1-3 Setting the Window Size to 0

An explanation is given on a situation in which the reproduction switch 17 is operated (arrow A3) while the image data contained in the packet transmitted from the external device 20 in step #16 are being recorded into the memory 12 (during a WR). The control circuit 9 records the image data in the packet already received at the interface circuit 13 into the memory 12. In addition, the control circuit 9 implements control on the interface circuit 13 in step #17 to transmit an acknowledgement with regard to the packet transmitted in step #16 and “window size=0”. Then, the control circuit 9 allows the memory 12 to immediately start a read operation (RD). This read operation is executed to transmits the image data required for the reproduction operation described earlier to the encoder/decoder circuit 11 from the memory 12.

In step #18, during which the image data are read out from the memory 12, the external device 20 transmits a new packet. Since the window size has been set to 0, this packet does not contain image data. Consequently, even when the image capturing system receives the packet transmitted from the external device 20 in step #18, it is not necessary to perform a write operation at the memory 12, thereby enabling the image capturing system to continuously read out the image data from the memory 12.

In step #19, the interface circuit 13 transmits an acknowledgement with regard to the packet transmitted in step #18 and “window size=0”. The window size is continuously set at 0 until the image data read from the memory 12 is completed. In step #20, the external device 20 transmits a new packet. Since the window size is still set at 0, as in step #19, the packet does not contain image data. Thus, the image capturing system continues to read out the image data from the memory 12.

In step #21 by which the image data read from the memory 12 is completed, the interface circuit 13 transmits an acknowledgement with regard to the packet transmitted in step #20 and “window size=1”. Accordingly, the external device 20 transmits a new packet containing image data in step #22. Upon receiving the packet transmitted from the external device 20, the interface circuit 13 converts the received packet to image data. The image data resulting from the conversion are sequentially recorded in the memory 12.

1-2 Data Write Achieved Through Internal Access Attempted While Data Read Through External Access is in Progress

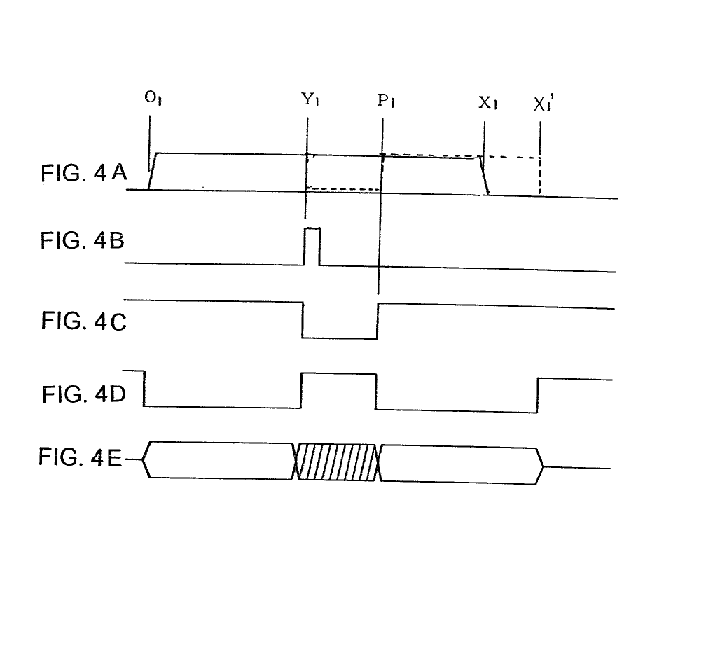

Next, an explanation as given on a situation in which the record switch 15 is operated while the transmit operation explained earlier is in progress at the image capturing system. In the first embodiment, if the record switch 15 is operated while data are read out from the memory 12 through the transmit operation, the data read from the memory 12 is interrupted to execute a record operation to write data into the memory 12. FIGS. 4A˜4E present time charts of the read control and the write control implemented on the memory 12. FIG. 4A shows the image data read out from the memory 12. FIG. 4B shows the operation signal input through the record switch 15. FIG. 4C shows the write control signal input to the memory 12. FIG. 4D shows the read control signal input to the memory 12. FIG. 4E shows the data at the input/output port of the memory 12.

In FIGS. 4A˜4E, a data read from the memory 12 is started by initiating external access at a time point corresponding to timing O1. Unless the record switch 15 is operated during the data read, the data read ends at a time point corresponding to timing X1. The solid line in FIG. 4A represents the waveform manifesting when the record switch 15 is not operated. When the record switch 15 is operated at a time point corresponding to timing Y1 in FIG. 4B, the control circuit 9 interrupts the data read at the memory 12. In FIG. 4D, the read control signal is in an active state when it is at low level and is in a non-active state when it is at high level. The control circuit 9 activates the read control signal at the time point O1 to allow the memory 12 to start a read operation. In response to an operation signal input through the record switch 15 at the time point Y1, the control circuit 9 deactivates the read control signal to interrupt the read operation at the memory 12.

In FIG. 4C, the write control signal is in an active state when it is at low level and is in a non-active state when it is at high level. During the transmit operation, the control circuit 9 sustains the write control signal in a non-active state to disallow a write operation at the memory 12. However, once the record switch 15 is operated, the write control signal is activated at the time point Y1 mentioned earlier to allow the memory 12 to start a write operation.

This write operation is executed to record into the memory 12 the image data obtained by compressing at the encoder/decoder circuit 11 data resulting from an image capturing operation performed at the image capturing element 1. In FIG. 4E, the shaded block indicates the data to be written into the memory 12. Namely, at the input/output port of the memory 12, data read out from the memory 12 are present between the time point O1 and the time point Y1 and data to be written into the memory 12 are present following the time point Y1 up to a time point corresponding to timing P1 to be detailed later.

When the data write executed to record the image data output from the encoder/decoder circuit 11 is completed, the control circuit 9 deactivates the write control signal and activates the read control signal at the time point P1. The memory 12 resumes the data read operation which was interrupted at the time point Y1. When the data read through the external access is completed, the control circuit 9 deactivates the read control signal at a time point corresponding to timing X1′. In FIG. 4A, the dotted line indicates the waveform manifesting between the time point P1 at which the data read from the memory 12 is resumed and the time point X1′ at which the data read is completed. The length of time elapsing between the time point X1 and the time point X1′ is equivalent to the length of time elapsing between the time point Y1 at which the data read was interrupted in response to an operation of the record switch 15 performed during the data read and the time point P1.

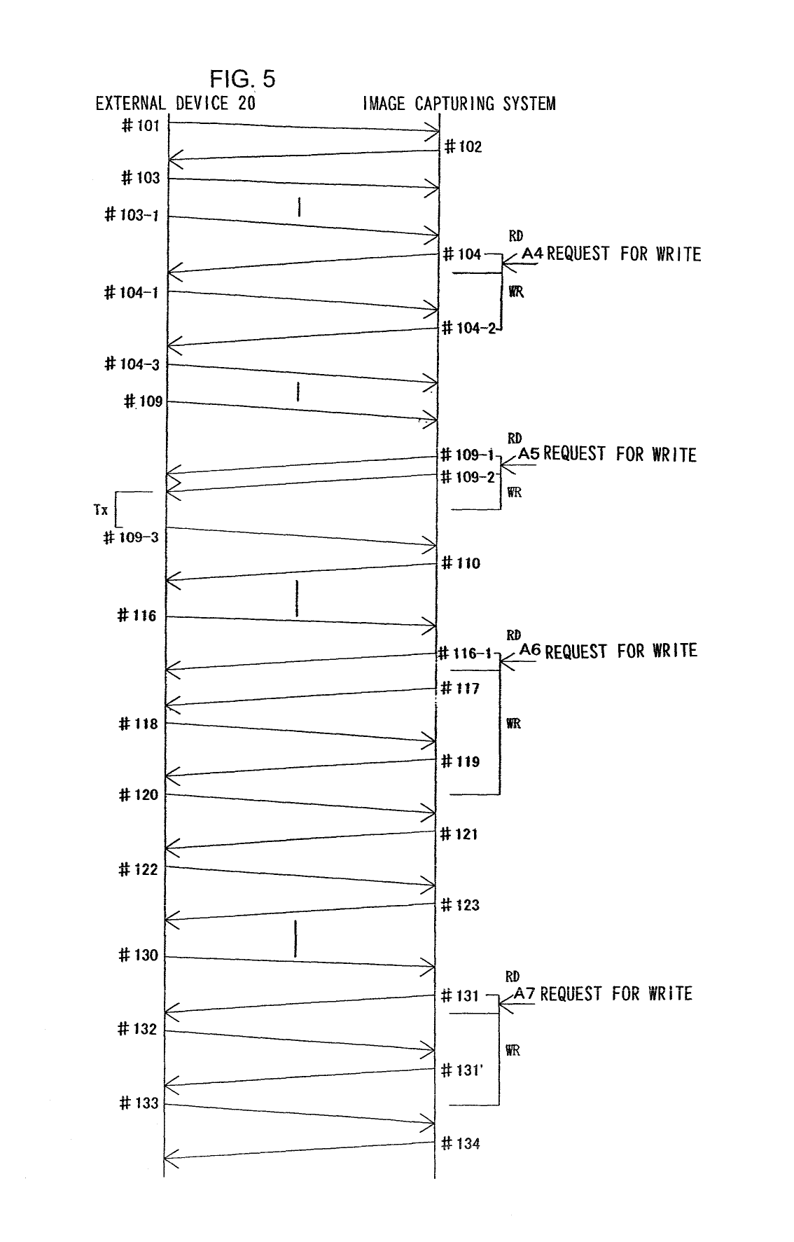

An explanation is given on the relationship between the read control and the write control implemented on the memory 12 described above, and the data communication achieved between the interface circuit 13 and the external device 20. FIG. 5 schematically illustrates the packet data communication achieved in conformance to TCP. In FIG. 5, the left side represents the external device 20 and the right side represents the image capturing system achieved in the first embodiment. In addition, the time is indicated along the vertical direction and the time advances toward the bottom in FIG. 5. Each arrow appended with # in the figure indicates a flow of data between the external device 20 and the image capturing system. FIG. 5 only presents the essential part of the data communication to facilitate the explanation and does not show the entire flow of the actual data.

After executing the write operation by interrupting the read operation in progress at the memory 12 at the time point Y1 in FIGS. 4A˜4E, the read operation may be resumed at the time point P1 through one of the following four methods.

1-2-1 Transmitting New Packet After Completion of Write Operation

In step #101 in FIG. 5, the external device 20 issues a line connection request to the image capturing system. In step #102, the interface circuit 13 of the image capturing system transmits a line connection response and a line connection request to the external device 20. In step #103, the external device 20 transmits a line connection response. Through the processing implemented in steps #101˜#103, the line connection between the external device 20 and the image capturing system is established. It is to be noted that the line connection requests described above each refer to a verification of the sequence number attached to the data to be transmitted/received. The sequence numbers are assigned in order to assure the reliability of the data communication.

In step #103-1, the external device 20 issues a request that a packet containing image data be transmitted. In response to the received request, the interface circuit 13 of the image capturing system transmits a packet containing image data in step #104. The image data contained in the packet are image data sequentially read out from the memory 12 by the control circuit 9. The interface circuit 13 converts the image data read out from the memory 12 to the data in a specific communication format and transmits them in a packet. Image data constituting one frame are divided into a plurality of portions and a plurality of packets each containing an image data portion resulting from the division are transmitted one at a time from the interface circuit 13.

Upon receiving the packet transmitted in step #104, the external device 20 converts the received packet to image data and implements specific processing on the image data resulting from the conversion. In step #104-1, the external device 20 transmits a packet containing an acknowledgement and a request that next image data be transmitted to the interface circuit 13. Upon receiving the acknowledgement and the request for the image data transmitted from the external device 20, the interface circuit 13 transmits the next packet containing image data.

If the record switch 15 explained earlier is operated (arrow A4) while the control circuit 9 is reading out the image data to be transmitted to the external device 20 from the memory 12 (during an RD), the control circuit 9 awaits the end of the image data read from the memory 12 which is still in progress. Immediately after the image data read is completed, the control circuit 9 implements control on the interface circuit 13 so as to disallow transmission of a new packet to the external device 20.

In the meantime, the control circuit 9 allows the memory 12 to start a write operation (WR). The write operation at the memory 12 is executed to record the compressed image data output from the encoder/decoder circuit 11 explained earlier. When image data for one frame have been recorded at the memory 12, the control circuit 9 implements control on the interface circuit 13 to transmit the packet in response to the request for the transmission which was transmitted from the external device 20 in step #104-1. Accordingly, the interface circuit 13 transmits the new packet containing image data in step #104-2. The image data contained in this packet are image data sequentially read out by the control circuit 9 from the memory 12 as described earlier. In step #104-3, the external device 20 receives the packet transmitted from the interface circuit 13 and transmits an acknowledgement.

1-2-2 Setting Time Period Tx

In step #109, the external device 20 issues a request that a packet containing image data be transmitted. In response to the received request, the interface circuit 13 of the image capturing system transmits a packet containing image data in step #109-1. The image data contained in the packet are image data sequentially read out from the memory 12 by the control circuit 9. Now an explanation is given on a situation in which the record switch 15 is operated (arrow A5) while the control circuit 9 is reading out the image data to be transmitted to the external device 20 from the memory 12 (during an RD). Upon receiving the operation signal from the record switch 15, the control circuit 9 waits for the image data read from the memory 12 which is still in progress to be completed.

In step #109-2, the control circuit 9 allows the memory 12 to start a write operation (WR) as soon as the image data read is completed. The write operation at the memory 12 is executed to record the compressed image data output from the encoder/decoder circuit 11. Concurrently as the memory 12 starts the write operation, the interface circuit 13 issues a request to the external device 20 that an acknowledgement with regard to the packet be transmitted after a period Tx. The period Tx is set longer than the length of time required to record image data for one frame in the memory 12. Accordingly, the external device 20 transmits the acknowledgement in step #109-3 following the period Tx which elapses after the request transmitted from the interface circuit 13 is received. By the time the packet transmitted in step #109-3 is received at the image capturing system, the processing for recording the image data corresponding to one frame in the memory 12 is completed. In step #110, the interface circuit 13 transmits a new packet containing image data. The image data contained in this packet are image data sequentially read out by the control circuit 9 from the memory 12. The external device 20 receives the transmitted packet and implements specific processing on it.

1-2-3 Setting Window Size to 0

In step #116, the external device 20 issues a request that a packet containing image data be transmitted. The interface circuit 13 at the image capturing system responds to the received request by transmitting a packet containing image data in step #116-1. The image data contained in this packet are image data sequentially read out by the control circuit 9 from the memory 12. An explanation is given on a situation in which the record switch 15 is operated (arrow A6) while the control circuit 9 is reading out the image data to be transmitted to the external device 20 from the memory 12 (during an RD). Upon receiving the operation signal from the record switch 15, the control circuit 9 waits for the read operation of the image data still in progress at the memory 12 to end.

The control circuit 9 allows the memory 12 to start a write operation (WR) immediately upon the completion of the image data read. The write operation is executed at the memory 12 to record the compressed image data that are output from the encoder/decoder circuit 11 described earlier. Concurrently as the memory 12 starts the write operation, the interface circuit 13 transmits a packet for notifying “window size=0” of a packet to be transmitted next to the external device 20 in step #117. (In the embodiment, the window size setting can be transmitted from the image capturing system on the transmission side). In step #118, the external device 20 transmits the “window size=0” of a packet to the interface circuit 13.

In step #119 during which the memory 12 is engaged in the write operation, the interface circuit 13 transmits a packet containing no image data in conformance to the window size set to 0 to the external device 20. In step #120, the external device 20 transmits an acknowledgement with regard to the received packet to the interface circuit 13. In step #121 following the completion of the write operation at the memory 12, the interface circuit 13 transmits a packet for notifying “window size=1” to the external device 20. In step #122, the external device 20 transmits “window size=1” set for the packet to the interface circuit 13.

In step #123, the interface circuit 13 transmits a new packet containing image data. The image data contained in this packet are image data sequentially read out by the control circuit 9 from the memory 12. The external device 20 receives the transmitted packet and implements specific processing on it.

1-2-4 Transmitting a Packet Repeatedly

In step #130, the external device 20 issues a request that a packet containing image data be transmitted. The interface circuit 13 at the image capturing system responds to the request that has received by transmitting a packet containing image data in step #131. The image data contained in this packet are image data sequentially read out by the control circuit 9 from the memory 12. An explanation is given on a situation in which the record switch 15 is operated (arrow A 7) while the control circuit 9 is reading out the image data to be transmitted to the external device 20 from the memory 12 (during an RD). Upon receiving the operation signal from the record switch 15, the control circuit 9 waits for the read operation of the image data still in progress at the memory 12 to end.

The control circuit 9 allows the memory 12 to start a write operation (WR) immediately upon the completion of the image data read. The write operation is executed at the memory 12 to record the compressed image data output from the encoder/decoder circuit 11 described earlier. Concurrently as the memory 12 starts the write operation, the control circuit 9 implements control the interface circuit 13 as described below. Namely, if the external device 20 issues a request that a packet containing image data be transmitted in step #132 during which the memory 12 is engaged in the write operation, the interface circuit 13 transmits in step #131′a packet containing the same data as those having been transmitted in step #130. The interface circuit 13 includes the internal memory 131 where the data having been transmitted most recently are stored. By reading out the data from the memory 131 during the packet transmission, the interface circuit 13 transmits a packet containing data which are the same as those having been transmitted previously.

In data communication achieved in conformance to the TCP in which the sequence numbers mentioned earlier are checked, the duplicate packet is discarded if the same packet is received repeatedly. Thus, the external device 20 is allowed to receive image data without an error since any duplicate data are discarded when packets containing identical data are repeatedly transmitted from the interface circuit 13.

In step #133 following the reception of the duplicate packet, the external device 20 issues an acknowledgement and a request that a packet containing image data be transmitted. In step #134 following the completion of the write operation at the memory 12, the interface circuit 13 transmits a new packet containing image data. The image data contained in this packet are image data sequentially read out by the control circuit 9 from the memory 12. The external device 20 receives the transmitted packet and implements specific processing on it.

The following advantages are achieved in the first embodiment explained above.

(1) The control circuit 9 interrupts an image data write into the memory 12 if the reproduction switch 17 is operated while image data transmitted from the external device 20 are written into the memory 12, and reads out image data from the memory 12 to execute a reproduction operation. Once the image data read is completed, the data write of the image data transmitted from the external device 20 into the memory 12 is resumed. In particular, the interface circuit 13 is not allowed to transmit an acknowledgement to the external device 20 until step #7 (see FIG. 3) following the completion of the image data read from the memory 12 of the image data for one frame required for the reproduction operation. As a result, no image data to be written into the memory 12 are transmitted from the external device 20 while the control circuit 9 is reading out data from the memory 12, thereby effectively preventing any conflict of access to the memory 12. In addition, since priority is given to an image data read from the memory 12 which is initiated in response to an operation of the reproduction switch 17 by the user of the image capturing system over the image data write into the memory 12, better operability is afforded for the user of the image capturing system.

(2) By specifying the specific period of time T to the external device 20 through transmission, the external device 20 is made to transmit image data to the interface circuit 13 in step #10 (see FIG. 3) following the completion of the image data read from the memory 12 of the image data for one frame required for the reproduction operation. As a result, no image data to be written into the memory 12, are transmitted from the external device 20 while the control circuit 9 is reading out data from the memory 12 thereby preventing any conflict of access to the memory 12.

(3) By specifying “window size=0” to the external device 20 through transmission, it is ensured that no image data to be written into the memory 12 are transmitted from the external device 20 until step #22 (see FIG. 3) following the completion of the image data read from the memory 12 of the image data for one frame required for the reproduction operation. As a result, no image data to be written into the memory 12 are transmitted from the external device 20 while the control circuit 9 is reading out the data from the memory 12, thereby preventing any conflict of access to the memory 12.

(4) If the record switch 15 is operated while image data to be transmitted to the external device 20 are read out from the memory 12, the control circuit 9 interrupts the image data read from the memory 12 and writes image data into the memory 12 for the record operation. Once the image data write is completed, the control circuit 9 resumes the read of the image data to be transmitted to the external device 20 from the memory 12. In particular, the next set of image data is not transmitted from the interface circuit 13 to the external device 20 until step #104-2 (see FIG. 5) following the completion of the write of the image data for one frame required for the record operation. As a result, the external device 20 does not transmit a request for a data read from the memory 12 while the control circuit 9 is writing data into the memory 12, thereby preventing any conflict of access to the memory 12.

(5) By specifying the period of time Tx to the external device 20 through transmission, the external device 20 is made to transmit a request for image data read in step #109-3 (see FIG. 5) following the completion of the image data write into the memory 12 of the image data for one frame required for the record operation. As a result, the external device 20 does not transmit a request for a data read from the memory 12 while the control circuit 9 is writing data into the memory 12, thereby preventing any conflict of access to the memory 12.

(6) By specifying “window size=0” to the external apparatus 20 through transmission, it is ensured that no image data are contained in the packet transmitted to the external device 20 until step #123 (see FIG. 5) following the completion of the image data write into the memory 12 of the image data for one frame required for the record operation. As a result, since it is not necessary to read out the image data to be transmitted to the external device 20 from the memory 12 while the control circuit 9 is writing the data into the memory 12, no conflict of access to the memory 12 occurs.

(7) Through the control implemented on the interface circuit 13, image data identical to those having been transmitted most recently are transmitted to the external device 20 until step #134 (see FIG. 5) following the completion of the image data write into the memory 12 of the image data for one frame required for the record operation. As a result, since it is not necessary to read out the image data to be transmitted to the external device 20 from the memory 12 while the control circuit 9 is writing the data into the memory 12, no conflict of access to the memory 12 occurs.

Second Embodiment

The second embodiment differs from the first embodiment in that if internal access occurs during external access to the memory 12, the external access is interrupted and the internal access is implemented in three separate parts.

2-1 Data Read Achieved Through Internal Access Attempted While Data Write Through External Access is in Progress

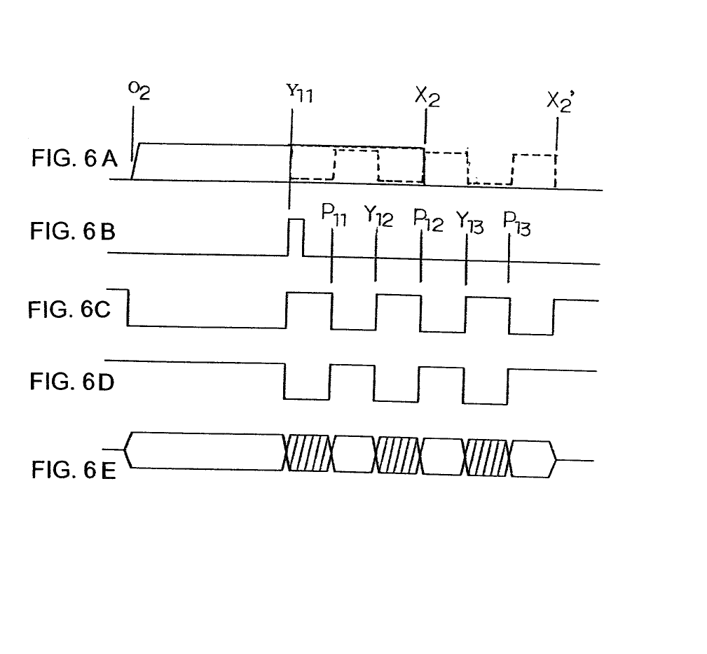

FIGS. 6A˜6E present time charts of the write control and the read control implemented on the memory 12. FIG. 6A shows image data and written into the memory 12. FIG. 6B shows the operation signal input through the reproduction switch 17. FIG. 6C shows the write control signal input to the memory 12. FIG. 6D shows the read control signal input to the memory 12. FIG. 6E shows the data at the input/output port at the memory 12.

In FIGS. 6A˜6E, a data write into the memory 12 is started through external access initiated at a time point corresponding to timing O2. Unless the reproduction switch 17 is operated while the data write is in progress, the data write is completed at a time point corresponding to timing X2. The solid line in FIG. 6A represents the waveform manifesting when the reproduction switch 17 is not operated. When the reproduction switch 17 is operated at a time point corresponding to timing Y11 in FIG. 6B, the control circuit 9 interrupts the data write into the memory 12. In FIG. 6C, the write control signal is in an active state when it is at low level and is in and non-active state when it is at high level. The control circuit 9 activates the write control signal at a time point corresponding to timing O2 to allow the memory 12 to start a write operation. In response to the operation signal input through the reproduction switch 17 at the time point corresponding to timing Y11, the control circuit 9 deactivates the write control signal to interrupt the write operation at the memory 12.

In FIG. 6D, the read control signal is in an active state when it is at low level and is in a non-active state when it is at high level. The control circuit 9 deactivates the read 5 control signal during a receive operation to disallow a read operation at the memory 12. However, once the reproduction switch 17 is operated, the control circuit 9 activates the read control signal at the time point corresponding to timing Y11 to allow the memory 12 to start a read operation. This read operation is performed to send image data recorded in the memory 12 to the encoder/decoder circuit 11. In FIG. 6E, the shaded block indicates the data read out from the memory 12. Namely, at the input/output port of the memory 12, the data to be written into the memory 12 are present between the time point O2 and the time point Y11, and the data read out from the memory 12 are present following the time point Y11 up to a time point corresponding to timing P11 which is to be detailed later.

When the data read performed to send the image data to the encoder/decoder circuit 11 is completed, the control circuit 9 deactivates the read control signal and activates the write control signal at the time point P11. The memory 12 resumes the data write operation which was interrupted at the time point Y11. In the second embodiment, when data are read out from the memory 12, the image data corresponding to one frame are read out in three parts over three separate reads. Namely, the read operation is executed over three periods, i.e., a period elapsing between the time point Y11 and the time point P11, a period elapsing between a time point corresponding to timing Y12 and a time point corresponding to timing P12 and a period elapsing between a time point corresponding to timing Y13 and a time point corresponding to timing P13. During the intervals between the individual reads, a write operation is executed. When the data write through the external access is completed, the control circuit 9 deactivates the write control signal at a time point corresponding to timing X2′. In FIG. 6A, the dotted line represents the waveform of the data write into the memory 12 implemented in three separate parts. The length of time elapsing between the time point x2 and the time point X2′ is equivalent to the total length of time required for the read operation executed over three separate parts during the data write.

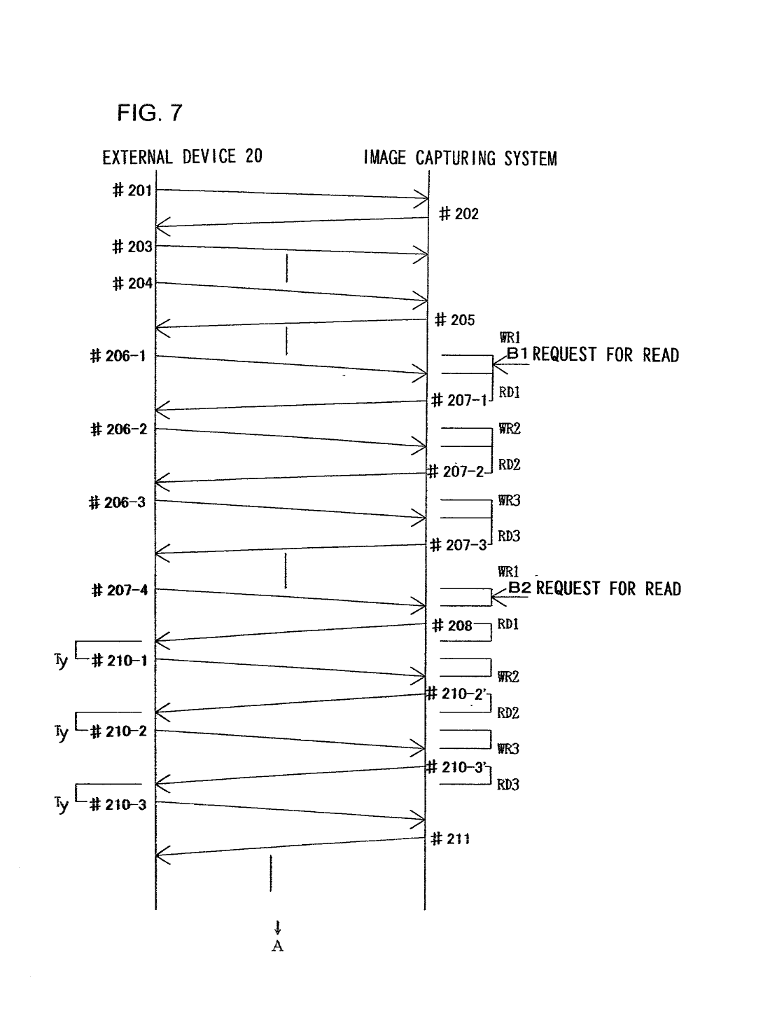

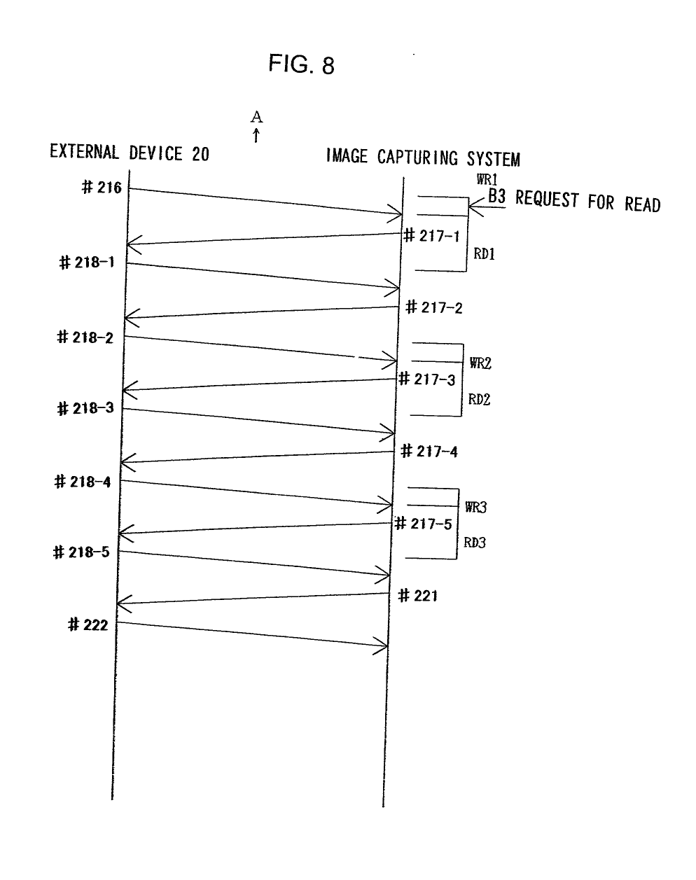

An explanation is given on the relationship between the write control and the read control implemented on the memory 12 described above, and the data communication achieved between the interface circuit 13 and the external device 20. FIGS. 7 and 8 schematically illustrate the packet data communication achieved in conformance to TCP. In FIGS. 7 and 8, the left side represents the external device 20 and the right side represents the image capturing system achieved in the second embodiment. In addition, the time is indicated along the vertical direction and as the time advances toward the bottom in FIGS. 7 and 8. Each arrow appended with # in the figures indicates a flow of data between the external device 20 and the image capturing system. FIGS. 7 and 8 only presents the essential part of the data communication to facilitate the explanation and does not show the entire flow of the actual data.

The following three methods are adopted to execute a read operation over three separate parts by interrupting the write operation in progress at the memory 12 at the time point Y11 in FIGS. 6A˜6E.

2-1-1 Temporarily Suspending Transmission of Acknowledgement

In step #201 in FIG. 7, the external device 20 issues a line connection request to the image capturing system. In step #202, the interface circuit 13 of the image capturing system transmits a line connection response and a line connection request to the external device 20. In step #203, the external device 20 transmits a line connection response. Through the processing implemented in steps #201˜#203, the line connection between the external device 20 and the image capturing system is established. It is to be noted that the line connection requests described above each refer to a verification of the sequence number attached to the data to be transmitted/received. The sequence numbers are assigned in order to assure the reliability of the data communication.

In step #204, the external device 20 transmits a packet containing image data. The interface circuit 13 of the image capturing system performs an error detection on the received data through a checksum. In step #205, the interface circuit 13 transmits an acknowledgement if no error has been detected. The error detection through checksum is executed each time a packet is received by the interface circuit 13. The interface circuit 13 does not transmit an acknowledgement if an error is detected.

In step #206-1, the external device 20 transmits a packet containing image data again. The image data constituting one frame are divided into a plurality of portions and a plurality of packets each containing an image data portion resulting from the division are transmitted one at a time from the external device 20. Upon receiving the packet transmitted in step #206-1, the interface circuit 13 converts the received packet to image data. The image data resulting from the conversion are sequentially recorded into the memory 12. After outputting the image data contained in the received packet, the interface circuit 13 transmits an acknowledgement to the external device 20. Upon receiving the acknowledgement transmitted from the interface circuit 13, the external device 20 transmits the next packet. If the reproduction switch 17 explained earlier is operated (arrow B1) while the image capturing system is recording image data into the memory 12 (during a WR1), the control circuit 9 records the image data contained in the packet that has already been received at the interface circuit 13 into the memory 12. In addition, the control circuit 9 implements control on the interface circuit 13 so that no acknowledgement is transmitted to the external device 20. As a result, the external device 20 does not transmit a new packet.

In the meanwhile, the control circuit 9 allows the memory 12 to start a read to operation (RD1). The read operation is performed at the memory 12 to send the image data required for the reproduction operation mentioned earlier to the encoder/decoder circuit 11 from the memory 12. Once the read of ⅓ of the image data for one frame required for the reproduction operation is completed, the control circuit 9 implements control on the interface circuit 13 so as to allow it to transmit an acknowledgement with regard to the packet transmitted in step #206-1. In step #207-1, the interface circuit 13 transmits the acknowledgement to the external device 20 only if no error has been detected through a checksum operation. As a result, the external device 20 transmits a new packet. containing image data in step #206-2.

The control circuit 9 records the image data contained in the packet received at the interface circuit 13 into the memory 12 (WR2). In addition, the control circuit 9 implements control on the interface circuit 13 so that no acknowledgement is transmitted to the external device 20. As a result, the external device 20 does not transmit a new packet. The control circuit 9 then allows the memory 12 to start a read operation (RD2). Once the read of ⅓ of the image data for one frame required for the reproduction operation is completed, the control circuit 9 implements control on the interface circuit 13 so as to allow it to transmit an acknowledgement with regard to the packet transmitted in step #206-2. In step #207-2, the interface circuit 13 transmits the acknowledgement to the external device 20 only if no error has been detected through a checksum operation. As a result, the external device 20 transmits a new packet containing image data in step #206-3.

The control circuit 9 records the image data contained in the packet received at the interface circuit 13 into the memory 12 (WR3). In addition, the control circuit 9 implements control on the interface circuit 13 so that no acknowledgement is transmitted to the external device 20. As a result, the external device 20 does not transmit a new packet. The control circuit 9 then allows the memory 12 to start the last read operation (RD3). Once the read of the last ⅓ of the image data for one frame required for the reproduction operation is completed, the control circuit 9 implements control on the interface circuit 13 so as to allow it to transmit an acknowledgement with regard to the packet transmitted in step #206-2. In step #207-3, the interface circuit 13 transmits the acknowledgement to the external device 20 only if no error has been detected through a checksum operation. As a result, the external device 20 is enabled to transmit a new packet containing image data.

2-1-2 Setting Period Ty

In step #207-4, the external device 20 transmits a packet containing image data. An explanation is now given on a situation in which the reproduction switch 17 is operated (arrow B2) while the image capturing system is recording the image data in the packet transmitted from the external device 20 into the memory 12 (during a WR1). Immediately after completing the processing for recording the image data contained in the packet already received at the interface circuit 13 into the memory 12, the control circuit 9 allows the memory 12 to start a read operation (RD1). The read operation is executed to transmit the image data required for the reproduction operation explained earlier to the encoder/decoder circuit 11 from the memory 12. During the read operation, ⅓ of the image data for one frame required for the reproduction operation is read out.

In step #208, the interface circuit 13 issues a request that the next packet containing the image data be transmitted from the external device 20 after a period Ty. The period Ty is set longer than the length of time required to read out ⅓ of the image data for one frame used to execute the reproduction operation from the memory 12. As a result, the external device 20 transmits the packet containing image data in step #210-1 following the period Ty which elapses after the request transmitted from the interface circuit 13 in step #208 is received. By the time the packet transmitted in step #210-1 is received at the image capturing system the image data read out from the memory 12 is completed.

The control circuit 9 records the image data contained in the packet received at the interface circuit 13 into the memory 12 (WR2). The control circuit 9 also allows the memory 12 to start a read operation (RD2). During the read operation, ⅓ of the image data for one frame required for the reproduction operation is read out. In step #210-2′, the interface circuit 13 transmits an acknowledgement. The external device 20 transmits a packet containing image data in step #210-2 following the period Ty which elapses after the acknowledgement transmitted from the interface circuit 13 in step 210-2′ is received.

The control circuit 9 records the image data contained in the packet received at the interface circuit 13 into the memory 12 (WR 3). The control circuit 9 also allows the memory 12 to start a read operation (RD 3). During the read operation, the last third of the image data for one frame required for the reproduction operation is read out. In step #210-3′, the interface circuit 13 transmits an acknowledgement. The external device 20 transmits a packet containing image data in step #210-3 following the period Ty which elapses after the acknowledgement transmitted from the external interface circuit 13 in step 210-3′ is received.

Upon receiving the packet transmitted in step #210-3, the interface circuit 13 transmits a packet indicating that the period Ty should be reset to the original value together with an acknowledgement in step #211.

2-1-3 Setting Window Size to 0

In step #216 in FIG. 8, the external device 20 transmits a packet containing image data. An explanation is given on a situation in which the reproduction switch 17 is operated (arrow B3) while the image data contained in the packet transmitted from the external device 20 are recorded into the memory 12 at the image capturing system (during a WR1). The control circuit 9 records the image data in the packet already received at the interface circuit 13 into the memory 12. In addition, the control circuit 9 implements control on the interface circuit 13 in step #217-1 to transmit an acknowledgement with regard to the packet transmitted in step #216 and window size=0. Then, the control circuit 9 allows the memory 12 to immediately start the read operation (RD1). This read operation is executed to transmits the image data required for the reproduction operation described earlier to the encoder/decoder circuit 11 from the memory 12. During the read operation, ⅓ of the image data for one frame required for the reproduction operation is read out.

In step #218-1, during which the image data are read out from the memory 12, the external device 20 transmits a new packet. Since the window size has been set to 0, this packet does not contain image data. Consequently, even when the image capturing system receives the packet transmitted from the external device 20 in step #218-1, it is not necessary to perform a write operation at the memory 12, thereby enabling the image capturing system to continuously read out the image data from the memory 12.

In step #217-2 following the completion of the read from the memory 12, the interface circuit 13 transmits “window size =1” together with an acknowledgement with regard to the packet transmitted in step #218-1. In response, the external device 20 transmits a new packet containing image data in step #218-2. The control circuit 9 records the image data contained in the packet received at the interface circuit 13 into the memory 12 (WR2). The control circuit 9 also implements control on the interface circuit 13 in step #217-3 to transmit “window size=0” together with an acknowledgement with regard to the packet transmitted in step #218-2. Then, the control circuit 9 allows the memory 12 to immediately start a read operation (RD2). During the read operation, ⅓ of the image data for one frame required to execute the reproduction operation is read out.

In step #218-3, during which the image data are read out from the memory 12, the external device 20 transmits a new packet. Since the window size has been set to 0, this packet does not contain image data. Consequently, even when the image capturing system receives the packet transmitted from the external device 20 in step #218-3, it is not necessary to perform a write operation at the memory 12, thereby enabling the image capturing system to continuously read out the image data from the memory 12.

In step #217-4 following the completion of the read from the memory 12, the interface circuit 13 transmits “window size =1” together with an acknowledgement with regard to the packet transmitted instep #218-3. In response, the external device 20 transmits a new packet containing image data in step #218-4. The control circuit 9 records the image data contained in the packet received at the interface circuit 13 into the memory 12 (WR 3). The control circuit 9 also implements control on the interface circuit 13 in step #217-5 to transmit “window size=0” together with an acknowledgement with regard to the packet transmitted in step #218-4. Then, the control circuit 9 allows the memory 12 to immediately start the last read operation (RD3). During the read operation, the last third of the image data for one frame required for the reproduction operation is read out. 5 In step #218-5, during which the image data are read out from the memory 12, the external device 20 transmits a new packet. Since the window size has been set to 0, this packet does not contain image data. Consequently, even when the image capturing system receives the packet transmitted from the external device 20 in step #218-5, it is not necessary to perform a write operation at the memory 12, thereby enabling the image capturing system to continuously read out the image data from the memory 12.

In step #221 following the completion of the read from the memory 12, the interface circuit 13 transmits “window size =1” together with an acknowledgement with regard to the packet transmitted in step #218-5. In response, the external device 20 is enabled transmit a new packet containing image data in step #222.

2-2 Data Write Achieved Through Internal Access Attempted While Data Read Through External Access is in Progress

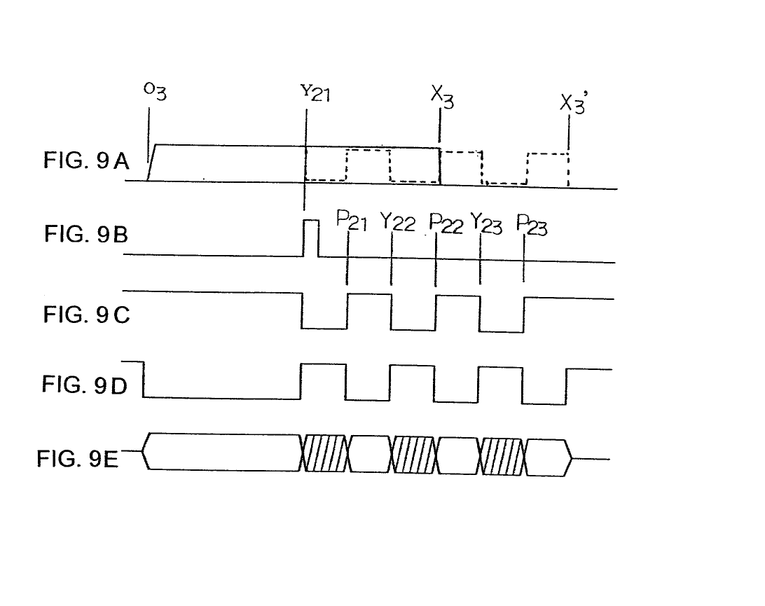

FIGS. 9A˜9E present time charts of the read control and the write control implemented on the memory 12. FIG. 9A shows the image data read out from the memory 12. FIG. 9B shows the operation signal input through the record switch 15. FIG. 9C shows the write control signal input to the memory 12. FIG. 9D shows the read control signal input to the memory 12. FIG. 9E shows the data at the input/output port of the memory 12.

In FIGS. 9A˜9E, a data read from the memory 12 is started by initiating external access at a time point corresponding to timing O3. Unless the record switch 15 is operated during the data read, the data read ends at a time point corresponding to timing X3. The solid line in FIG. 9A represents the waveform manifesting when the record switch 15 is not operated. When the record switch 15 is operated at a time point corresponding to timing Y21 in FIG. 9B, the control circuit 9 interrupts the data read at the memory 12. In FIG. 9D, the read control signal is in an active state when it is at low level and is in a non-active state when it is at high level. The control circuit 9 activates the read control signal at the time point O3 to allow the memory 12 to start a read operation. In response to the operation signal input through the record switch 15 at the time point Y21, the control circuit 9 deactivates the read control signal to interrupt the read operation at the memory 12.

In FIG. 9C, the write control signal is in an active state when it is at low level and is in a non-active state when it is at high-level. During the transmit operation, the control circuit 9 sustains the write control signal in a non-active state to disallow a write operation at the memory 12. However, once the record switch 15 is operated, the write control signal is activated at the time point Y21 mentioned earlier to allow the memory 12 to start a write operation.

This write operation is executed to record into the memory 12 the image data obtained by compressing at the encoder/decoder circuit 11 image data resulting from an image capturing operation performed at the image capturing element 1. In FIG. 9E, the shaded block indicates the data to be written into the memory 12. Namely, at the input/output port of the memory 12, data read out from the memory 12 are present between the time point O3 and the time point Y21 and data to be written into the memory 12 are present following the time point Y21 up to a time point corresponding to timing P21 to be detailed later.

When the data write executed to record the image data output from the encoder/decoder circuit 11 is completed, the control circuit 9 deactivates the write control signal and activates the read control signal at the time point P21. The memory 12 resumes the data read operation which was interrupted at the time point Y21. In the second embodiment, data are written into the memory 12 by writing the image data for one frame in three separate parts, i.e., ⅓ of the image data written at a time. Namely, the write operation is executed over three separate periods, i.e., a period of time elapsing between the time point corresponding to timing Y21 and the time point corresponding to timing P21, a period elapsing between a time point corresponding to timing Y22 and a time point corresponding to timing P22 and a period elapsing between a time point corresponding to timing Y23 and a time point corresponding to timing P23. During the intervals between the individual writes, a read operation is executed. When the data read through the external access is completed, the control circuit 9 deactivates the read control signal at a time point corresponding to timing X3′. In FIG. 9A, the dotted line represents the waveform of the data read from the memory 12 executed in three separate parts. The length of time elapsing between the time point X3 and the time point X3′ is equivalent to the total length of time required for the write operation executed over three separate parts during the data read.

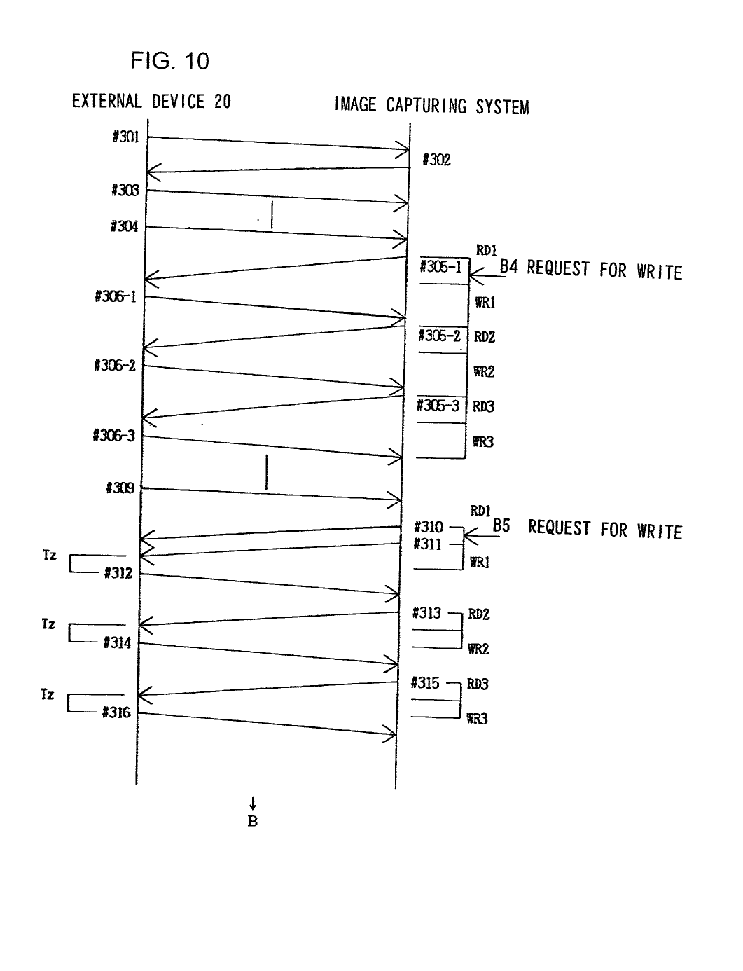

An explanation is given on the relationship between the read control and the write control implemented on the memory 12 described above, and the data communication achieved between the interface circuit 13 and the external device 20. FIGS. 10˜12 schematically illustrate the packet data communication achieved in conformance to TCP. In FIGS. 10-12, the left side represents the external device 20 and the right side represents the image capturing system achieved in the second embodiment. In addition, the time is indicated along the vertical direction and the time advances toward the bottom in FIGS. 10˜12. Each arrow appended with # in the figures indicates a flow of data between the external device 20 and the image capturing system. FIGS. 10˜12 only present the essential part of the data communication to facilitate the explanation and do not show the entire flow of the actual data.

The following four methods may be adopted to execute a write operation in three separate parts by interrupting the read operation and progress at the memory 12 at the time point Y21 in FIGS. 9A˜9E.

2-2-1 Transmitting New Packet After Completion of Write Operation

In step #301 in FIG. 10, the external device 20 issues a line connection request to the image capturing system. In step #302, the interface circuit 13 of the image capturing system transmits a line connection response and a line connection request to the external device 20. In step #303, the external device 20 transmits a line connection response. Through the processing implemented in steps #301˜#303, the line connection between the external device 20 and the image capturing system is established. It is to be noted that the line connection requests described above each refer to a verification of the sequence number attached to the data to be transmitted/received. The sequence numbers are assigned in order to assure the reliability of the data communication.

In step #304, the external device 20 issues a request that a packet containing image data be transmitted. In response to the received request, the interface circuit 13 of the image capturing system transmits a packet containing image data in step #305-1. The image data contained in the packet are image data sequentially read out from the memory 12 by the control circuit 9. The interface circuit 13 converts the image data read out from the memory 12 to data in the communication format and transmits them in a packet. Image data constituting one frame are divided into a plurality of portions and a plurality of packets each containing an image data portion resulting from the division are transmitted one at a time from the interface circuit 13.

Upon receiving the packet transmitted in step #305-1, the external device 20 converts the received packet to image data and implements specific processing on the image data resulting from the conversion. In step #306-1, the external device 20 transmits a packet containing an acknowledgement and a request that next image data be transmitted to the interface circuit 13. Upon receiving the acknowledgement and the request for the image data transmitted from the external device 20, the interface circuit 13 transmits the next packet containing image data.

If the record switch 15 explained earlier is operated (arrow B4) while the control circuit 9 is reading out the image data to be transmitted to the external device 20 from the memory 12 (during an RD1), the control circuit 9 awaits the end of the image data read from the memory 12 which is still in progress. Immediately after the image data read is completed, the control circuit 9 implements control on the external interface circuit 13 so as to disallow transmission of a new packet to the external device 20.

In the meantime, the control circuit 9 allows the memory 12 to start a write operation (WR1). The write operation is executed at the memory 12 to record the compressed image data output from the encoder/decoder circuit 11 explained earlier. When ⅓ of the image data for one frame has been recorded at the memory 12, the control circuit 9 implements control on the interface circuit 13 to transmit a packet in response to the request for the transmission which was transmitted from the external device 20 in step #306-1.

The control circuit 9 reads out the image data from the memory 12 (RD2) and transmits the image data thus read out to the interface circuit 13. In step #305-2, the interface circuit 13 transmits the next packet containing the image data. Immediately after the image data read is completed, the control circuit 9 implements control on the interface circuit 13 so that no new packet is transmitted to the external apparatus 20.

When the read operation at the memory 12 is completed, the control circuit 9 immediately allows the memory 12 to start a write operation (WR2). The write operation executed at the memory 12 to record the compressed image data output from the encoder/decoder circuit 11 explained earlier. When ⅓ of the image data for one frame has been recorded at the memory 12, the control circuit 9 implements control on the interface circuit 13 to transmit the packet, the request for the transmission of which was transmitted from the external device 20 in step #306-2.

The control circuit 9 reads out the image data from the memory 12 (RD 3) and transmits the image data thus read out to the interface circuit 13. In step #305-3, the interface circuit 13 transmits the next packet containing the image data. Immediately after the image data read is completed, the control circuit 9 implements control on the interface circuit 13 so that no new packet is transmitted to the external apparatus 20.

When the read operation at the memory 12 is completed, the control circuit 9 immediately allows the memory 12 to start a write operation (WR3). The write operation is executed at the memory 12 to record the compressed image data output from the encoder/decoder circuit 11 explained earlier. When the last third of the image data for one frame has been written into the memory 12, the control circuit 9 implements control on the interface circuit 13 to transmit the packet, the request for the transmission of which was transmitted from the external device 20 in step #306-3.

2-2-2 Setting Time Period Tz

In step #309, the external device 20 issues a request that a packet containing image data be transmitted. In response to the received request, the interface circuit 13 of the image capturing system transmits a packet containing image data in step #310. The image data contained in the packet are image data sequentially read out from the memory 12 by the control circuit 9. Now an explanation is given on a situation in which the record switch 15 is operated (arrow B5) while the control circuit 9 is reading out the image data to be transmitted to the external device 20 from the memory 12 (during an RD1). Upon receiving the operation signal from the record switch 15, the control circuit 9 waits for the image data read from the memory 12 which is still in progress to be completed.

Immediately after the image read is completed, the control circuit 9 allows the memory 12 to start a write operation (WR1). The write operation at the memory 12 is executed to record the compressed image data output from the encoder/decoder circuit 11 mentioned earlier. The write operation is performed on ⅓ of the image data for one frame to be written into the memory 12. When the memory 12 starts the write operation, the interface circuit 13 issues a request to the external device 20 in step #311 that an acknowledgement with regard to the packet be transmitted after a period Tz. The period Tz is set longer than the length of time required to record ⅓ of the image data for one frame into the memory 12.

As a result, the external device 20 transmits the acknowledgement in step #312 following the period Tz which elapses after the request transmitted from the interface circuit 13 is received. By the time the packet transmitted in step #312 is received at the image capturing system, the processing for recording the image data into the memory 12 is completed. The control circuit 9 reads out the image data from the memory 12 (RD2) and transmits the image data thus read out to the interface circuit 13. In step #313, the interface circuit 13 transmits the next packet containing image data. Immediately after the image data read (RD2) is completed, the control circuit 9 allows the memory 12 to start a write operation (WR2). The write operation at the memory 12 is executed to record the compressed image data output from the encoder/decoder circuit 11 mentioned earlier. The write operation is performed on ⅓ of the image data for one frame to be written into the memory 12.

The external device 20 transmits an acknowledgement in step #314 following the period Tz which elapses after the packet transmitted from the interface circuit 13 is received. By the time the packet transmitted in step #314 is received at the image capturing system, the processing for recording the image data into the memory 12 is completed. The control circuit 9 reads out the image data from the memory 12 (RD3) and transmits the image data thus read out to the interface circuit 13. In step #315, the interface circuit 13 transmits the next packet containing image data. Immediately after the image data read (RD3) is completed, the control circuit 9 allows the memory 12 to start the last write operation (WR3) The write operation at the memory 12 is executed to record the compressed image data output from the encoder/decoder circuit 11 mentioned earlier. The write operation is performed on the last third of the image data for one frame to be written into the memory 12.

The external device 20 transmits an acknowledgement in step #316 following the period Tz which elapses after the packet transmitted from the interface circuit 13 is received.

2-2-3 Setting Window Size to 0

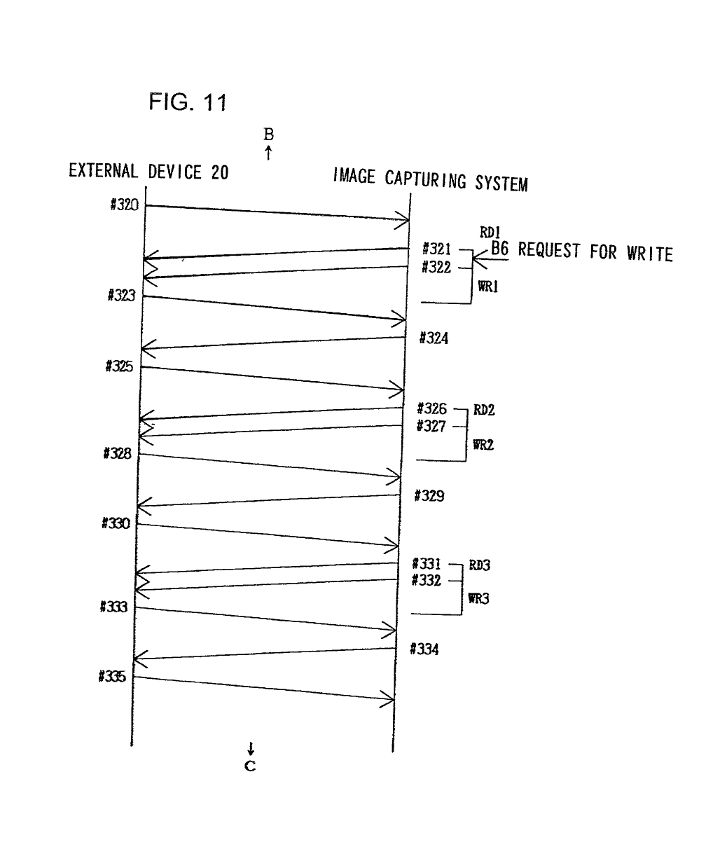

In step #320 in FIG. 11, the external device 20 issues a request that a packet containing image data be transmitted. The interface circuit 13 at the image capturing system responds to the received request by transmitting a packet containing image data in step #321. The image data contained in this packet are image data sequentially read out by the control circuit 9 from the memory 12. An explanation is given on a situation in which the record switch 15 is operated (arrow B6) while the control circuit 9 is reading out the image data to be transmitted to the external device 20 from the memory 12 (during an RD1). Upon receiving the operation signal from the record switch 15, the control circuit 9 waits for the read out operation of the image data still in progress at the memory 12 to end.

In step #322, the control circuit 9 allows the memory 12 to start a write operation (WR1) immediately upon the completion of the image data read. The write operation is executed at the memory 12 to record the compressed image data output from the encoder/decoder circuit 11 described earlier. The write operation is executed on ⅓ of the image data for one frame to be written into the memory 12. Concurrently as the memory 12 starts the write operation, the interface circuit 13 transmits a packet for notifying “window size=0” of a packet to be transmitted next, to the external device 20. (In the embodiment, the window size setting can be transmitted from the image capturing system on the transmission side). In step #323, the external device 20 transmits “window size=0” of a packet to the interface circuit 13.

In step #324 following the completion of the write operation at the memory 12, the interface circuit 13 transmits a packet for notifying “window size=1” to the external device 20. In step #325, the external device 20 transmits “window size=1” of a packet to the interface circuit 13.

The control circuit 9 reads out the image data from the memory 12 (RD2) and transmits the image data thus read out to the interface circuit 13. In step #326, the external Ad interface circuit 13 transmits the next packet containing the image data. The control circuit 9 allows the memory 12 to start a write operation (WR2) immediately upon the completion of the image data read (RD2). The write operation is executed at the memory 12 to record the compressed image data output from the encoder/decoder circuit 11 described earlier. The write operation is executed on ⅓ of the image data for one frame to be written into the memory 12. Concurrently as the memory 12 starts the write operation, the interface circuit 13 transmits a packet for notifying “window size=0” of a packet to be transmitted next to the external device 20 in step #327. In step #328, the external device 20 transmits “window size=0” of a packet to the interface circuit 13.

In step #329 following the completion of the write operation at the memory 12, the interface circuit 13 transmits a packet for notifying “window size=1” to the external device 20. In step #330, the external device 20 transmits “window size=1” of a packet to the external interface circuit 13.

The control circuit 9 reads out the image data from the memory 12 (RD3) and transmits the image data thus read out to the interface circuit 13. In step #331, the interface circuit 13 transmits the next packet containing the image data.

The control circuit 9 allows the memory 12 to start the last 5 write operation (WR3) immediately upon the completion of the image data read (RD3). The write operation is executed at the memory 12 to record the compressed image data output from the encoder/decoder circuit 11 described earlier. The write operation is executed on the last third of the image data for one frame to be written into the memory 12. Concurrently as the memory 12 starts the write operation, the interface circuit 13 transmits a packet for notifying “window size=0” of a packet to be transmitted next to the external device 20 in step #332. In step #333, the external device 20 transmits “window size=0” of a packet to the interface circuit 13.

In step #334 following the completion of the write operation at the memory 12, the interface circuit 13 transmits a packet for notifying “window size=1” to the external device 20. In step #335, the external device 20 transmits “window size=1” of a packet to the interface circuit 13.

2-2-4 Transmitting Same Packet Repeatedly

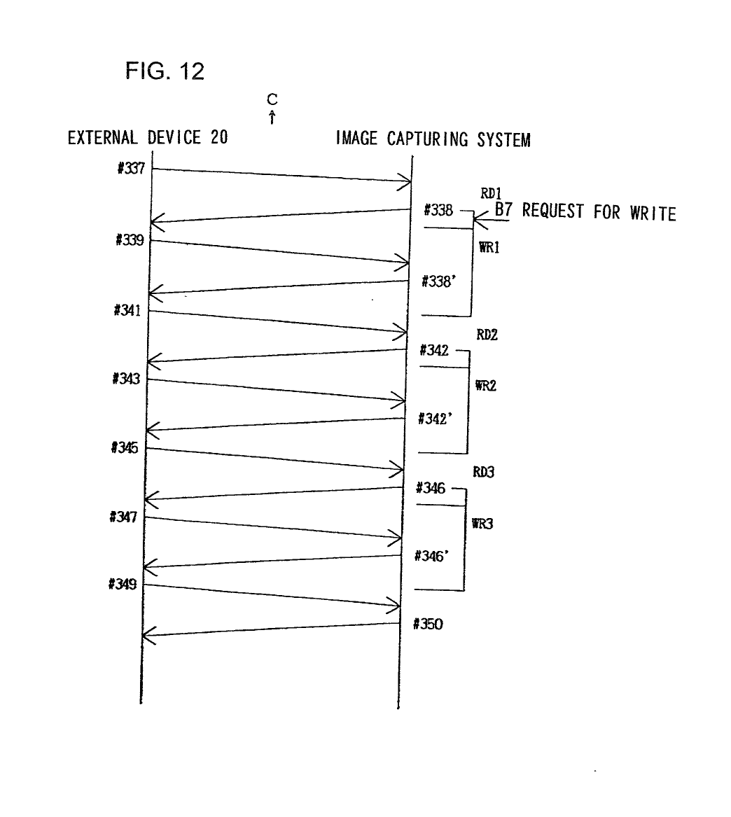

In step #337 in FIG. 12, the external device 20 issues a request that a packet containing image data be transmitted. The interface circuit 13 at the image capturing system responds to the received request by transmitting a packet containing image data in step #338. The image data contained in this packet are image data sequentially read out by the control circuit 9 from the memory 12. An explanation is given on a situation in which the record switch 15 is operated (arrow B7) while the control circuit 9 is reading out the image data to be transmitted to the external device 20 from the memory 12 (during an RD1). Upon receiving the operation signal from the record switch 15, the control circuit 9 waits for the read out operation of the image data still in progress at the memory 12 to end.

The control circuit 9 allows the memory 12 to start a write operation (WR1) immediately upon the completion of the image data read. The write operation is executed at the memory 12 to record the compressed image data output from the encoder/decoder circuit 11 described earlier. The write operation is performed on ⅓ of the image data for one frame to be written into the memory 12. Concurrently as the memory 12 starts the write operation, the control circuit 9 implements control on the interface circuit 13 as described below. Namely, if the external device 20 issues a request that a packet containing image data be transmitted in step #339 during which the memory 12 is engaged in the write operation, the 13 transmits in step #338′ a packet containing the same data as those having been transmitted in step #338. The interface circuit 13 includes the internal memory 131 where the data having been transmitted most recently are stored. By reading out the data from the memory 131 during the packet transmission, the interface circuit 13 transmits a packet containing data which are the same as those having been transmitted previously.

In a data communication achieved in conformance to TCP in which the sequence numbers mentioned earlier are checked, the duplicate packet is discarded if packets containing identical image data are received repeatedly. Thus, the external device 20 is allowed to receive image data without an error since any duplicate data are discarded when packets containing identical data are repeatedly transmitted from the interface circuit 13. In step #341 following the reception of the duplicate packet, the external device 20 issues an acknowledgement and a request that a packet containing image data be transmitted.

The control circuit 9 reads out the image data from the memory 12 (RD2) and transmits the image data thus read out to the interface circuit 13. In step #342, the interface circuit 13 transmits the next packet containing image data.

Immediately after the image data read (RD2) is completed, the control circuit 9 allows the memory 12 to start a write operation (WR2). The write operation is executed at the memory 12 to record the compressed image data output from the encoder/decoder circuit 11 explained earlier. The write operation is performed on ⅓ of the image data for one frame to be written into the memory 12.

If the external device 20 issues a request that a packet containing image data be transmitted instep #343 during which the write operation is in progress at the memory 12, the interface circuit 13 transmits in step #342′ a packet containing the same data as those having been transmitted in step #342. In step #345 following the reception of the duplicate packet, the external device 20 issues an acknowledgement and a request that a packet containing image data be transmitted.

The control circuit 9 reads out the image data from the memory 12 (RD3) and transmits the image data thus read out to the interface circuit 13. In step #346, the interface circuit 13 transmits the next packet containing the image data. Immediately after the image data read (RD3) is completed, the control circuit 9 allows the memory 12 to start a write operation (WR3). The write operation at the memory 12 is executed to record the compressed image data output from the encoder/decoder circuit 11 mentioned earlier. The write operation is performed on the last third of the image data for one frame to be written into the memory 12.

If the external device 20 issues a request got up packet containing image data be transmitted in step #347 during which the write operation is in progress at the memory 12, the interface circuit 13 transmits in step #346′ a packet containing the same data as those having been transmitted in step #346.

In step #349 following the reception of the duplicate packet, the external device 20 issues an acknowledgement and a request that a packet containing image data be transmitted. The control circuit 9 reads out new image data from the memory 12 and transmits the image data thus read out to the interface circuit 13. In step #350, the interface circuit 13 transmits the next packet containing the image data.

The following advantages are achieved by adopting the second embodiment explained above.

(1) If the reproduction switch 17 is operated while image data transmitted from the external device 20 are written into the memory 12, the control circuit 9 interrupts the image data write into the memory 12 and reads out the image data from the memory 12 in three separate parts, i.e., ⅓ of the image data at a time, to execute the reproduction operation. Once the image data read is completed, the write of the image data transmitted from the external device 20 into the memory 12 is resumed. By reading the image data from the memory 12 in a plurality of parts, the length of time required for each read can be reduced. As a result, the likelihood of image data being retransmitted from the external device 20 while the image data are read from the memory 12 is reduced, to prevent the transmission efficiency of the communication medium 19 from becoming lowered. In addition, since priority is given to the image data read from the memory 12 initiated by an operation of the reproduction switch 17 performed by the user of the image capturing system over the image data write into the memory 12, better operability is afforded for the user of the image capturing system.

(2) No acknowledgement is transmitted from the interface circuit 13 to the external device 20 until steps #207-1, #207-2 and # 207-3 (see FIG. 7) each following the completion of the image data read from the memory 12 of ⅓ of the image data for one frame required for the reproduction operation. Thus, no image data to be written into the memory 12 are transmitted from the external device 20 while the control circuit 9 is reading out the data from the memory 12, thereby preventing any conflict of access to the memory 12.

(3) By specifying the period Ty to the external device 20 through transmission, the image data are transmitted from the external device 20 to the interface circuit 13 insteps #210-1, #210-2 and #210-3 (see FIG. 7) each following the completion of the image data read from the memory 12 of ⅓ of the image data for one frame required for the reproduction operation. Thus, no image data to be written into the memory 12 are transmitted from the external device 20 while the control circuit 9 is reading out the data from the memory 12, thereby preventing any conflict of access to the memory 12.

(4) By specifying the “window size=0” to the external device 20 through transmission, no image data to be written into the memory 12 are transmitted from the external device 20 until steps #218-2, #218-4 and #222 (see FIG. 8) each following the completion of the image data read from the memory 12 of ⅓ of the image data for one frame required for the reproduction operation. Thus, no image data to be written into the memory 12 are transmitted from the external device 20 while the control circuit 9 is reading out the data from the memory 12, thereby preventing any conflict of access to the memory 12.

(5) If the record switch 15 is operated while the image data to be transmitted to the external device 20 are read out from the memory 12, the control circuit 9 interrupts the image data read at the memory 12 and writes the image data into the memory 12 in three separate parts to execute a record operation. Once the image data write is completed, the read of the image data from the memory 12 to be transmitted to the external device 20 is resumed. By writing the image data into the memory 12 in a plurality of parts, the length of time required for each write operation can be reduced. Consequently the likelihood of a request for an image data read being issued from the external device 20 while the image data write is in progress at the memory 12 is lowered to prevent the transmission efficiency of the communication medium 19 from becoming reduced.

(6) The next set of image data is not transmitted from the interface circuit 13 to the external device 20 until steps #305-2, and#305-3 (see FIG. 10) each following the completion of the image data write into the memory 12 of ⅓ of the image data for one frame required for the record operation. Thus, since no request for a data read from the memory 12 is transmitted from the external device 20 while the control circuit 9 is writing the data into the memory 12, no conflict of access to the memory 12 occurs.

(7) By specifying the period Tz to the external device 20 through transmission, it is ensured that the external device 20 transmits a request for an image data read in steps #312, #314 and #316 (see FIG. 10) each following the completion of the image data write into the memory 12 of ⅓ of the image data for one frame required for the record operation. Thus, since no request for a data read from the memory 12 is transmitted from the external device 20 while the control circuit 9 is writing the data into the memory 12, no conflict of access to the memory 12 occurs.

(8) By specifying “window size=0” to the external device 20 through transmission, it is ensured that no image data are contained in the packet transmitted to the external device 20 until steps #326 and #331 (see FIG. 11) each following the completion of the image data write into the memory 12 of ⅓ of the image data for one frame required for the record operation. As a result, since it is not necessary to read out the image data to be transmitted to the external device 20 from the memory 12 while the control circuit 9 is writing the data into the memory 12, no conflict of access to the memory 12 occurs.

(9) Through the control implemented on the interface circuit 13, the same image data as those having been transmitted previously are transmitted to the external device 20 until steps #342, #346 and #350 (see FIG. 12) each following the completion of the image data write into the memory 12 of ⅓ of the image data for one frame required for the record operation. As a result, since it is not necessary to read out the image data to be transmitted to the external device 20 from the memory 12 while the control circuit 9 is writing the data into the memory 12, no conflict of access to the memory 12 occurs.

In the second embodiment explained above, the image data required for the reproduction operation are read out by the control circuit 9 from the memory 12 in three separate parts. In addition, the control circuit 9 writes the image data into the memory 12 in three separate parts in order to execute the record operation. However, the number of parts over which data are read out or written does not need to be three.

In the explanation given above, the packet (image data) having been transmitted most recently is stored in the memory 131 provided at the interface circuit 13 to repeatedly transmit the same image data (#131′, #338′, #342′, #346′). The memory for storing the packet (image data) having been transmitted most recently may be provided in the control circuit 9 instead.

In the explanation given above, the present invention is adopted to execute: 1; a data read through internal access while a data write through external access is in progress and 2; a data write through internal access while a data read through external access is in progress. In addition, it may be adopted to execute: 3; a data write through internal access while and data write through external access is in progress and 4; a data read through internal access while a data read through external access is in progress. When executing data write through both the external access and the internal access, the write control signal is activated for each access and the read control signal is deactivated for each access. If, on the other hand, a data read is to be executed through both the external access and the internal access, the read control signal is activated and the write control signal is deactivated for each access. In other words, the same control signals are not activated at the same time during the external access and the internal access.

The memory 5 and the memory 12 mentioned above may be constituted of a single memory. In addition, at least either the memory 5 or the memory 12 may be constituted of a removable recording medium such as a CF card.

The encoder/decoder circuit 11 does not need to be provided at the image capturing system. In addition, through the control implemented by the control circuit 9 on the encoder/decoder circuit 11, image data read out from the memory 5 may be directly written into the memory 12 without implementing data compression processing on the image data.

In the explanation given above, image data corresponding to one frame are recorded and reproduced through the record operation initiated in response to an operation of the record switch 15 and through the reproduction operation initiated in response to an operation of the reproduction switch 17. Instead of image data for one frame, image data for a plurality of frames may be recorded and reproduced. In such a case, the memory 5 and the memory 12 should have storage capacities large enough to store image data corresponding to a plurality of frames.

The present invention may be adopted in conjunction with any communication medium 19 regardless of whether it is connected through wired connection or wireless connection, as long as it is capable of packet data communication.

While the present invention is adopted in the image capturing system in the embodiments explained above, the control processing achieved in the image capturing system (the control processing for executing write/read at the memory 12 through the external access, the control processing for executing write/read at the memory 12 through the internal access) may be stored as a software program in a recording medium such as a CD-ROM or a floppy disk. The control processing program may then be read on a personal computer or the like to be utilized to record image data into a memory or reproduce image data by taking image data recorded by an electronic camera and image data transmitted from an external apparatus into the personal computer.

Instead of reading the control processing program from the recording medium where it is stored in the personal computer as described above, the control processing program may be transmitted via a transmission medium such as the Internet. In this case, the transmitted program is read at the personal computer to be utilized to implement the image data recording/reproduction processing described earlier.

What is claimed is;

1. An image capturing system comprising:
an image capturing element that captures an image of a subject and outputs image information;
a storage circuit in which image information is stored;
a switch through which a start instruction to start internal access to said storage circuit in response to an operation performed by a user is issued;
an interface that enables communication with an external apparatus; and
a control circuit that interrupts external access and executes internal access to said storage circuit when said start instruction is received during the external access in which the external apparatus accesses said storage circuit via said interface.

2. An image capturing system according to claim 1, wherein:
said start instruction is an instruction for starting a write of image information output by said image capturing element; and
the image information from said image capturing element is written into said storage circuit through internal access.

3. An image capturing system according to claim 1, further comprising:
a display storage circuit employed to output image information stored in said storage circuit to a display device, wherein:
said start instruction is an instruction for updating image information stored in said display storage circuit; and
image information stored in said storage circuit is read out to said display storage circuit through internal access.

4. An image capturing system according to claim 1, wherein:
image information received from the external apparatus via said interface is written into said storage circuit through external access.

5. An image capturing system according to claim 1, wherein:
image information recorded in said storage circuit is read out to the external apparatus via said interface through external access.

6. An image capturing system according to claim 1, wherein:
said control circuit disallows external access until internal access following an interruption of external access is completed.

7. An image capturing system according to claim 1, wherein:
said control circuit executes internal access and external access alternately until internal access following an interruption of external access is completed.

8. An image capturing system according to claim 4, wherein:
said control circuit outputs internal access end information to the external apparatus via said interface, based upon a fact that internal access following an interruption of external access is completed.

9. An image capturing system according to claim 4, wherein:
said control circuit interrupts external access, and outputs access restart time information indicating when communication with the external apparatus is allowed to resume, to the external apparatus via said interface.

10. An image capturing system according to claim 5, wherein:
said control circuit restarts external access based upon a fact that internal access following an interruption of external access is completed.

11. An image capturing system according to claim 5, wherein:
said control circuit interrupts external access, and outputs access restart time information indicating when communication with the external apparatus is allowed to resume, to the external apparatus via said interface.

12. An image capturing system according to claim 5, further comprising:
a buffer in which a portion of image information stored in said storage circuit is temporarily stored before the image information stored in said storage circuit is read out to the external apparatus via said interface, wherein
said control circuit outputs the portion of the image information stored in said buffer to the external apparatus via said interface when an image information transfer request is issued by the external apparatus before internal access following an interruption of external access is completed.

13. A computer readable recording medium having recorded therein a control processing program for an image capturing system, said program comprising:
an image capturing instruction for capturing an image of a subject and outputting image information;
a storage instruction for storing image information in a storage circuit;
a start instruction for starting internal access to the storage circuit in response to an operation performed by a user;
a communication instruction for communicating with an external apparatus; and
an execution instruction for interrupting external access and executing internal access to the storage circuit when said start instruction is received during external access in which the external apparatus accesses the storage circuit.
